(19) United States
(12) Patent Application Publication
(10) Pub. No.: US 2026/0138359 A1
(43) Pub. Date: May 21, 2026

(54) SILICONE-THERMOPLASTIC COMPOSITE ARTICLES

(71) Applicant: DOW SILICONES CORPORATION, Midland, MI (US)

(72) Inventors: Yenny CUBIDES, Midland, MI (US); Noel CHANG, Midland, MI (US); Kaila MATTSON, Midland, MI (US); Dongchan AHN, Midland, MI (US); Michael BACKER, Wiesbaden (DE)

(21) Appl. No.: 19/122,245

(22) PCT Filed: Oct. 17, 2023
(86) PCT No.: PCT/US2023/035281

§ 371 Date: Apr. 17, 2025

Related U.S. Application Data
(60) Provisional application No. 63/417,431, filed on Oct. 19, 2022.

(51) Int. Cl. B32B 27/18; B32B 27/08; B32B 27/28; B32B 27/34; B32B 37/18; B32B 38/00

(52) U.S. Cl. CPC B32B 27/18; B32B 27/08; B32B 27/283; B32B 27/34; B32B 37/182; B32B 2038/0076; B32B 2262/101; B32B 2305/08; B32B 2305/72; B32B 2307/3065; B32B 2307/308; B32B 2307/50; B32B 2315/00; B32B 2367/00; B32B 2377/00; B32B 2383/00; B32B 2457/00

(57) ABSTRACT

Disclosed are methods to maintain the durability of silicone-thermoplastic composite articles, which comprise flame-retardant thermoplastics and silicone elastomeric materials, with age by incorporating a stabilizing additive in the silicone elastomeric materials. This disclosure also provides improved silicone-thermoplastic composite articles and uses for such silicone-thermoplastic composite articles. A silicone-thermoplastic composite article comprises: (i) a thermoplastic article comprising one or more flame-retardant additives, wherein the thermoplastic article has an available surface; and (ii) a cured silicone elastomer part in direct contact with the available surface of the thermoplastic article (i). The silicone elastomer part is the cured product of a silicone elastomer composition comprising from 0.25 wt. % to a maximum of 5 wt. % of a stabilizing additive. The stabilizing additive is selected from the group consisting of magnesium carbonates, magnesium hydroxy carbonates, magnesium oxide, and mixtures thereof.

The present disclosure relates to a silicone-thermoplastic composite article and a method for maintaining the durability of silicone-thermoplastic composite articles, which comprise flame-retardant thermoplastics and silicone elastomeric materials with age, by incorporating a stabilizing additive in the silicone elastomeric materials. The present disclosure also extends to uses for such silicone-thermoplastic composite articles.

Curable silicone rubber compositions are known in the art and are used to prepare silicone elastomeric materials having a broad spectrum of physical properties including electrical insulation, resistance and stability to heat, freeze resistance, abrasion resistance, fire retardancy, and long-term flexibility. This unique combination of properties renders silicone elastomers suitable for utilisation in a wide range of electrical and/or insulative applications.

For example, silicone elastomers made from either liquid silicone rubbers (LSRs) or high consistency rubbers (HCRs) have been used in a wide variety of silicone-thermoplastic composite articles which increasingly comprise flame-retardant thermoplastics and silicone elastomeric materials. The physical properties of the thermoplastic materials and silicone elastomeric materials can provide the composite articles with advantageous properties not present if either one or the other were used instead of the composite. In recent times there has been a propensity to incorporate flame retardant additives in thermoplastic materials, given increasing safety requirements around the world. This has proven highly beneficial for thermoplastics but has brought into question the durability of silicone elastomeric materials when used in combination in such composite articles.

Without being bound by current theories, it has been suggested that when in close contact, especially when under compression together, flame-retardant additives are migrating with time into the silicone elastomeric materials negatively affecting the physical properties and durability of the silicone elastomeric material. This is believed to be causing a loss in durability of the silicone elastomeric material leading to the failure of the composite article.

For example, one of the most common applications for silicone elastomeric materials in silicone-thermoplastic composite articles are as seals in or for electrical or electronic connectors, commonly used to create closed electrical circuits in automotive, residential, and infrastructural settings. This is due to their excellent balance of mechanical properties, chemical and thermal stabilities and ease of processing. Such electrical or electronic connectors may be used for mating with rigid thermoplastic housing components to form a tight connection that provides both electrical and environmental isolation to connector junctions to create closed electrical circuits in e.g., automotive, residential, and infrastructural settings.

Such electrical or electronic connectors may, for example, be used in automotive vehicles which are becoming increasingly dependent on electrical and electronical systems, especially with the developments in electric and hybrid vehicles. In these applications, the silicone rubber seals are subjected to mechanical compression and high temperatures and are potentially exposed to the presence of moisture, oils and fuels, corrosive gases, and effluents from contacted materials (e.g., thermoplastic housings) but must retain their mechanical integrity and dimensional stability to provide proper sealing performance during service life to prevent electrical failure.

Silicone-thermoplastic composite articles are also useful in other applications where the cured silicone serves to seal, passivate, or protect componentry from environmental and mechanical challenges including heat, moisture, dust, and vibration, as -exemplified by lid seals and adhesives for-electronic module housings; gaskets or seals for radiator tank or headlamp assemblies; and pottants or encapsulants for electrical or electronic components found in automotive, marine, aeronautical, aerospace or and other industrial applications.

It is important therefore for the silicone elastomeric material to maintain its physical properties to ensure the durability of both the silicone elastomeric material itself and the silicone-thermoplastic composite articles. One of the most important physical properties which the silicone rubber material needs to retain is having a low compression set for applications requiring e.g., environmental and electrical insulation and/or heat stability.

Compression set is a thermally induced fatigue behavior of a silicone elastomeric material which may be defined as the loss in ability of said silicone elastomeric material to recover to its original thickness after compression for specific period of time at a set (elevated) temperature. A compression set value may be measured, for example, following the industrial standard ASTM D395-18 methods A, B or C and is identified as a percentage, such that if there is complete recovery, i.e., if the thickness of a test specimen is identical before and after the application of a load, the compression set is 0%; if, in contrast, a 25% compression of a silicone elastomeric material applied during a test remains unchanged when the load is removed, the compression set is 100% because it has failed to return to its original shape at all.

Many silicone elastomeric materials have a substantial compression set e.g., of greater than 50% or even greater than 60% even after compression at temperatures of 125° C. and 150° C. for short periods of time e.g., 22 hours and can suffer from problems caused by a consequential change in shape and/or a significant increase in hardness during long-term service in high-temperature applications unless they undergo a post-cure heating process.

“Post curing” is the most straightforward way to minimise compression set where hydrosilylation or peroxide-cured silicone materials are subjected to a period of several hours e.g., four or more hours of post-cure heating at temperature of 150° C. or greater. However, post-curing is not usually commercially desired or indeed viable given capital investment required due to the need for increased energy consumption and delays in manufacturing times.

Many applications described above typically desire silicone elastomeric materials having a compression set value which is as low as possible e.g., no greater than 40%, across a wide spectrum of temperatures.

In the United States electrical connector systems have to meet the requirements of the SAE International USCAR-2 “Performance Specification for Automotive Electrical Connector Systems” testing regime. Sealed connector assemblies are graded for their suitability for use over specified temperature ranges fulfilling a class of relevant automotive specifications for given temperature ranges. Currently there are five ranges identified as T1-T5:
T1 is for the temperature class −40° C. to +85° C.;
T2 is for the temperature range −40° C. to +100° C.;
T3 is for the temperature range −40° C. to +125° C.;
T4 is for the temperature range −40° C. to +150° C.; and currently the highest grade is
T5 for the −40° C. to 175° C.

Given it is not desirable to post cure every silicone elastomer after cure, a variety of additives have been proposed as an alternative way to reduce compression set.

However, industrial and vehicle components and modules are increasingly subjected to mechanical compression and exposed to increasing working temperatures of greater than 125° C.

Furthermore, the necessity for the manufacturing and automotive industries to increasingly meet more complex fire safety requirements and/or regulations has led to a greater demand for the utilisation of flame-retardant (FR) plastics, especially flame-retardant thermoplastics for e.g., connector housings.

Whilst the use of flame-retardant thermoplastics has provided the ability to meet some of the fire safety requirements and/or regulations it has been reported that many silicone elastomer materials used in combination with the flame-retardant thermoplastics in silicone-thermoplastic composite articles, e.g., in connector seal applications, suffer from premature seal failure after having been in direct contact with flame retardant-rated plastics. Despite their well-known advantages due to physical properties, because of the premature failure, silicone elastomers are viewed as incompatible with the flame-retardant thermoplastics in some flame retardant-rated systems.

The intention of this disclosure is to provide a means of maintaining the durability of silicone-thermoplastic composite articles which comprise flame-retardant thermoplastics and silicone elastomeric materials with age.

There is provided herein a silicone-thermoplastic composite article comprising
(i) a thermoplastic article comprising one or more flame retardant additives, wherein the thermoplastic article has an available surface, and
(ii) a cured silicone elastomer part in direct contact with the available surface of the thermoplastic article (i), wherein the silicone elastomer part is the cured product of a silicone elastomer composition comprising from 0.25 wt. % to a maximum of 5 wt. % of a stabilizing additive selected from the group consisting of magnesium carbonates, magnesium hydroxy carbonates, magnesium oxide, and a mixture thereof.

There is also provided herein a method of fabricating a silicone-thermoplastic composite article comprising
(a) providing a curable silicone elastomer composition comprising from 0.25 to a maximum of 5 wt. % of a stabilizing additive selected from the group consisting of magnesium carbonates, magnesium hydroxy carbonates, magnesium oxide, and a mixture thereof,
(b) curing said curable elastomer composition into a mold,
(c) physically engaging the cured silicone elastomer with an available surface of a thermoplastic article (i) comprising one or more flame-retardant additives to form a silicone-thermoplastic composite article.

There is also provided herein a method of fabricating a silicone-thermoplastic composite article as described above comprising
(a) providing a curable silicone elastomer composition comprising from 0.25 wt. % to a maximum of 5 wt. % of stabilizing additive selected from the group consisting of magnesium carbonates, magnesium hydroxy carbonates, magnesium oxide, and a mixture thereof,
(b) contacting the curable silicone elastomer composition with an available surface of a thermoplastic article (i) comprising one or more flame retardant additives
(c) curing the curable silicone elastomer composition in contact with the available surface of the flame retardant thermoplastic article, to form a silicone-thermoplastic composite article.

There is further provided herein a method for fabricating a silicone-thermoplastic composite article, wherein the silicone-thermoplastic composite article comprises
(i) a thermoplastic article comprising one or more flame-retardant additives,
   wherein the thermoplastic article has an available surface; and
(ii) a silicone elastomer part, wherein the silicone elastomer part is physically engaged with the available surface of (i) the thermoplastic article comprising one or more flame-retardant additives;
which method comprises:
(1) providing a curable silicone elastomer composition comprising a hydrosilylation reaction curable silicone elastomer composition or a free radical reaction curable silicone elastomer composition,
   wherein the curable silicone elastomer composition further comprises 0.25 wt. % to a maximum of 5.0 wt. % of a stabilizing additive selected from the group consisting of a magnesium carbonates, magnesium hydroxy carbonates, magnesium oxide, and a mixture thereof;
(2) introducing a desired amount of the curable silicone elastomer composition into a mold,
(3) curing the curable silicone elastomer composition, thereby forming (ii) the silicone elastomer part;
(4) physically engaging (ii) the silicone elastomer seal and the available surface of (i) the thermoplastic article comprising one or more flame-retardant additives, thereby forming the silicone-thermoplastic composite article.

In one embodiment of the latter, the silicone-thermoplastic composite article is an electrical or electronic connector, wherein the electrical or electronic connector comprises
(ia) one or more electrical wires;
(ib) an electrical or electronic connector housing comprising a thermoplastic material and one or more flame-retardant additives,
   wherein the electrical or electronic connector housing (ib) has a first (outer) available surface and a second (inner) surface opposite the outer surface,
      wherein the second (inner) surface defines a cavity, and
      the cavity houses the one or more electrical wires (ia) therein; and
the silicone elastomer part (ii) is a silicone elastomer seal, wherein the silicone elastomer seal is physically engaged with the first (outer) available surface of the electrical or electronic connector housing (ib).

In the above method there may be a step (5) comprising: connecting the electrical or electronic connector into a connector junction of an electrical circuit via (i) the one or more electrical wires, thereby providing environmental and electrical isolation for the one or more electrical wires (ia). Furthermore, the electrical or electronic connector may be heated at a temperature≥125° C. for 1008 hours, wherein the silicone elastomer seal is in a compressed state, e.g., 25%.

There is also provided a method to maintain the durability of a silicone elastomer part in physical contact with a flame-retardant thermoplastic having an available surface which silicone elastomer part in use is subjected to mechanical compression and exposed to temperatures of greater than 85° C. comprising the steps of
(1′) preparing a curable silicone elastomer composition wherein the curable silicone elastomer composition further comprises 0.25 wt. % to a maximum of 5.0 wt. % of a stabilizing additive selected from the group consisting of magnesium carbonates, magnesium hydroxy carbonates, magnesium oxide, and a mixture thereof
(2′) introducing a desired amount of the curable silicone elastomer composition into a mold,
(3′) curing the curable silicone elastomer composition, thereby forming the silicone elastomer part (ii);
(4′) physically engaging the silicone elastomer part (ii) and the available surface of the flame-retardant thermoplastic, to form a silicone-thermoplastic composite article.

There is also provided a silicone elastomer seal which in use is subjected to mechanical compression and exposed to temperatures of greater than 85° C. obtainable by a process comprising the steps of
(1′) preparing a curable silicone elastomer composition selected from a hydrosilylation reaction curable silicone elastomer composition or a free radical reaction curable silicone elastomer composition, wherein the curable silicone elastomer composition further comprises 0.25 wt. % to a maximum of 5.0 wt. % of a stabilizing additive selected from the group consisting of magnesium carbonates, magnesium hydroxy carbonates, magnesium oxide, and a mixture thereof
(2′) introducing a desired amount of the curable silicone elastomer composition into a mold,
(3′) curing the curable silicone elastomer composition, thereby forming the silicone elastomer seal (ii).

There is also provided a use of from 0.25 wt. % to a maximum of 5.0 wt. % of an additive selected from the group consisting of magnesium carbonates, magnesium hydroxy carbonates, magnesium oxide, and a mixture thereof as a stabilizing additive in a silicone elastomer part in physical contact with a flame-retardant thermoplastic.

In one embodiment, in use, said silicone elastomer part e.g., a seal is subjected to mechanical compression and exposed to temperatures of greater than 85° C. and/or the silicone elastomer part e.g., seal is otherwise formed from a curable silicone elastomer composition selected from a hydrosilylation reaction curable silicone elastomer composition or a free radical reaction curable silicone elastomer composition.

Surprisingly it has been identified that the problem encountered when seeking to use silicone elastomer materials in combination with a flame-retardant thermoplastic/thermoplastic article comprising one or more flame-retardant additives in silicone-thermoplastic composite articles, e.g., in connector seal applications, i.e., the need to avoid premature silicone elastomer seal failure after having been in direct contact with flame retardant-rated thermoplastics can be overcome by introducing a stabilizing additive in the form of from 0.25 wt. % to a maximum of 5.0 wt. % of an additive selected from the group consisting of magnesium carbonates, magnesium hydroxy carbonates, magnesium oxide, and a mixture thereof in the silicone elastomer compositions used to form e.g., a silicone elastomer seal in a silicone-thermoplastic composite article.

The addition of the stabilizing additive maintains the durability e.g., the mechanical integrity and dimensional stability of the silicone elastomer part in the silicone-thermoplastic composite article comprising a thermoplastic containing fire retardant additives, because it appears to maintain the silicone elastomer's physical properties such as compression set, despite migration of the fire retardant additives into the silicone elastomer. For example, it prevents any significant worsening of silicone elastomer compression set in a silicone elastomer seal which, in use, is subjected to mechanical compression and exposed to temperatures of greater than 85° C., alternatively greater than 100° C., alternatively greater than 125° C. The silicone-thermoplastic composite articles as described herein are made using silicone elastomers made from the compositions described herein in combination with any suitable flame-retardant thermoplastic.

The flame-retardant thermoplastics are typically used in silicone-thermoplastic composite articles to form rigid components with the silicone elastomers molded or otherwise dispensed into desired shapes designed to form a tight connection over and/or around the thermoplastic article. Usually, the silicone elastomer is provided as a form of seal designed in conjunction with the rigid flame-retardant component to provide both environmental and electrical isolation to the connector junctions. The silicone-thermoplastic composite articles as described herein may comprise any suitable flame-retardant thermoplastic comprising a thermoplastic containing up to 10 wt. % of one or more flame-retardant additives, or even more.

The thermoplastic may, for example, be condensation polymers including polyamides such as nylons e.g., nylon 6 (PA6), nylon 6,6 (PA6,6), heat resistant nylon 6T/6,6 (PA6T/6,6), nylon 6/10 (PA6/10), nylon 6/12 (PA6/12), nylon 11 (PA11), nylon 12 (PA12) and the like, and polyoxymethylene, polyphenylenesulfide (PPS), polyacetals, polyamide-imides, polypthalamides, polyetherimides, polyetherketone, polyether etherketone, polyether ketone ether ketone, polyoxymethylene(acetal) homopolymer copolymers, syndiotactic polystyrene (sPS) and compatibilized blends of sPS with polyamides; condensation polymers such as polyesters including polyethylene terephthalate (PET), polybutylene terephthalate (PBT), polyarylate (PAR), and the like; polycarbonate (PC) (including impact-modified polycarbonate); polyethers such as polyphenyleneoxide (PPO), maleic anhydride grafted polyphenyleneoxide (PPO), maleic anhydride grafted olefinic elastomers and plastomers, polysulfone, polyethersulfone, polyarylsulfone, polyphenylene ether, and the like; polypropylene, polyethylene, aliphatic polyketones (PK) thermoplastic styrene copolymers, such as acrylonitrile styrene acrylate (ASA), acrylonitrile butadiene styrene (ABS) and styrene acrylonitrile (SAN); polymethyl methacrylate (PMMA), polyoxymethylene (POM). Preferably this process is provided to be used in conjunction with PA6, PA6,6, PA6T/6,6, PBT, PC and PK, especially PA6, PA6,6, PA6T/PA6,6, and PBT. The thermoplastic can also contain about 25-35 wt. % of glass fibers (GF) as a reinforcement additive, e.g., PA6-GF25, PA6,6-GF25, PA6T/6,6-GF33, PK-GF30 and PBT-GF30.

The flame-retardants (FRs) utilised in the flame-retardant thermoplastics/thermoplastic articles comprising one or more flame-retardant additives maybe any suitable flame-retardant material, such as, for the sake of example, brominated flame retardants e.g., hexabromocyclododecane, chlorinated paraffins, melamine-based flame retardants e.g., melamine cyanurate and melamine polyphosphates, organo-phosphorus flame retardants such as aromatic phosphorus flame retardants, polyphosphates flame retardants such as propylammonium (poly)phosphates, ammonium polyphosphate, triphenyl phosphate, dimethyl methylphosphonate, tris(2,3-dibromopropyl) phosphate (brominated tris) and metal hydroxide flame retardants such as aluminium trihydrate, etc. as well as mixtures or derivatives thereof. Preferably the flame-retardants utilised are non-halogenated flame-retardants, alternatively organo-phosphorus flame retardants and melamine-based flame retardants in combination with inorganic phosphorus flame retardants which are most commonly used in conjunction with silicone elastomers in silicone-thermoplastic composite articles.

Flame retardants have been classified by their chemical structures in accordance with ISO 1043-4.

The most relevant categories are:
FR(17): Aromatic brominated compounds (excluding brominated diphenyl ether and biphenyls) in combination with antimony compounds;
FR(30): Nitrogen compounds (confined to melamine, melamine cyanurate, urea);
FR(5X): Inorganic phosphorus compounds where X=0 and X=1 correspond to ammonium orthophosphates and ammonium polyphosphates, respectively; and
FR(40): halogen-free organic phosphorus compounds such as such as triphenyl phosphate (TPP), resorcinol bis(diphenylphosphate) (RDP), bisphenol A diphenyl phosphate (BADP), and tricresyl phosphate (TCP).

The silicone elastomers used in the silicone-thermoplastic composite articles are typically molded or otherwise dispensed into desired shapes designed to form a tight connection over and/or around the thermoplastic article. It is surmised that species in the flame-retardant thermoplastics are migrating into the silicone elastomers when fixed tightly over the thermoplastics materials and this is negatively affecting the chemical structure of the silicone elastomer and consequently negatively affecting the loss in compression set in the silicone elastomers when in direct contact with the thermoplastics in silicone-thermoplastic composite articles.

As described herein it has now been surprisingly identified that the inclusion of from 0.25 wt. % to a maximum of 5.0 wt. % of a stabilizing additive selected from the group consisting of magnesium carbonates, magnesium hydroxy carbonates, magnesium oxide, and a mixture thereof into the curable silicone elastomer compositions used to make the silicone elastomers maintain their durability and avoid premature failure of the silicone elastomer part such as a seal by rendering e.g., a significant improvement in physical properties such as the retention of compression set properties of silicone elastomers used in conjunction with flame-retardant thermoplastics in the aforementioned silicone-thermoplastic composite articles. This is particularly surprising because other materials such as magnesium hydroxide (Mg(OH)₂), zinc oxide (ZnO), calcium carbonate (CaCO₃) exhibit no effect. Similarly, acid scavengers such as disodium phosphate (Na₂HPO₄) or traditional antioxidants and high temperature compression set additives, such as iron (III) oxide (Fe₂O₃)manganese carbonate (MnCO₃), and copper phthalocyanine complexes, do not provide any benefits.

While not being tied to this hypothesis, we propose that there is a migration of flame retardant species from the thermoplastic into the silicone elastomer by way of solid-state diffusion and these species are causing degradation of the silicone matrix resulting in poorer physical properties including, for the sake of example, an increase in compression set.

It is also believed that the stabilizing additives herein are interacting with these diffusive species in a way that they stop or slow down the degradation of the silicone elastomer. This in our view is a surprising effect particularly because other materials one might have expected to have a similar effect, e.g., acid scavengers such as calcium carbonate, magnesium hydroxide, zinc oxide don't appear to have a similar effect.

Because the silicone elastomers used in the silicone-thermoplastic composite articles are designed to form a tight connection over and/or around the thermoplastic article, when the silicone-thermoplastic composite articles are electrical or electronic connectors, the silicone elastomers are designed/shaped to provide both electrical and environmental isolation to the connector junctions.

However, given their positioning within e.g., engines etc. relative to other parts the silicone elastomeric seals are under mechanical compression and exposed to high temperatures.

They can also be in the presence of moisture, oils, fuels, corrosive gases, and exposed to effluents from contacted materials (e.g., flame retardant plastics) and as such it is critical that the silicone elastomers have a suitable compression set which enables retention of their mechanical integrity and dimensional stability to provide proper sealing performance during service life.

The silicone elastomers used in the silicone-thermoplastic composite articles may be prepared by curing suitable curable silicone elastomer composition selected from a hydrosilylation reaction curable silicone elastomer composition or a free radical reaction curable silicone elastomer composition. The curable silicone elastomer composition may be made from either liquid silicone rubbers (LSRs) or high consistency rubbers (HCRs) as both, upon cure, result in silicone elastomers having an excellent balance of mechanical properties, chemical properties and thermal stability.

Liquid silicone rubbers tend to be hydrosilylation curable silicone rubber composition, which comprises the following components:
a) one or more polyorganosiloxanes containing at least two unsaturated groups, selected from alkenyl groups and alkynyl groups, per molecule and having a viscosity in a range of from 1000 mPa·s to 100,000 mPa·s at 25° C.;
b) a silica reinforcing filler which is optionally hydrophobically treated; and
c1) a hydrosilylation cure package comprising
   c1(i)) an organosilicon compound having at least two, alternatively at least three Si—H groups per molecule; and
   c1(ii)) a hydrosilylation catalyst comprising or consisting of a platinum group metal or a compound thereof;

In the current disclosure the liquid silicone rubber (LSR) composition must also incorporate additional component (d) wherein:
(d) is from 0.25 wt. % to a maximum of 5.0 wt. % of a stabilizing additive selected from the group consisting of magnesium carbonates, magnesium hydroxy carbonates, magnesium oxide, and a mixture thereof.

A variety of optional additives to suit the application for which the elastomer resulting from cure is to be used may also be incorporated into the composition.

High consistency silicone rubbers usually contain much higher viscosity/chain length/molecular weight polymers which are typically measured on the basis of their Williams plasticity value rather than viscosity. Williams plasticity is measured in accordance with ASTM D-926-08. Because of their exceptionally high viscosities they are often referred to in the industry as “polymer gums”.

Typically, the high consistency rubber compositions differ from LSR compositions described above and comprises the following components:
a″) one or more polyorganosiloxanes having a Williams plasticity of at least 100 mm/100 in accordance with ASTM D-926-08 and
b″) a silica reinforcing filler which is optionally hydrophobically treated.

High consistency silicone rubber compositions may be hydrosilylation cured in which case polymer a′ must also contain at least two unsaturated groups, selected from alkenyl groups and alkynyl groups; and the composition comprises a hydrosilylation cure package c1″) or a free radical curative c2″) wherein
c1″) is a hydrosilylation cure package comprising
   c1(i)″) an organosilicon compound having at least two, alternatively at least three Si—H groups per molecule; and
   c1(ii)″) a hydrosilylation catalyst comprising or consisting of a platinum group metal or a compound thereof;

Alternatively, the high consistency silicone rubber compositions may be free-radical vulcanised, typically utilising organoperoxides. In the event the composition used is a high consistency silicone rubber composition in which case the at least two unsaturated groups, selected from alkenyl groups and alkynyl groups are optional in polymer a″ and the composition additionally comprises c2″) a free radical curative.

In the current disclosure the high consistency silicone rubber compositions must also incorporate additional component (d″) wherein:
(d″) is 0.25 wt. % to a maximum of 5.0 wt. % of a stabilizing additive selected from the group consisting of magnesium carbonates, magnesium hydroxy carbonates, magnesium oxide, and a mixture thereof. Again, a variety of optional additives to suit the application for which the elastomer resulting from cure is to be used may also be incorporated into the composition.

In the case of a liquid silicone rubber:

### Component (a)

Component (a) of the liquid silicone rubber composition is one or more polyorganosiloxanes containing at least two unsaturated groups, selected from alkenyl groups and alkynyl groups, per molecule and having a viscosity in a range of from 1000 mPa·s to 100,000 mPa·s at 25° C.

Component (a) of the liquid silicone rubber composition is a polyorganosiloxane, such as a polydiorganosiloxane having at least two unsaturated groups per molecule, which unsaturated groups are selected from alkenyl or alkynyl groups. Alternatively, component (a) has at least three unsaturated groups per molecule.

The unsaturated groups of component (a) may be terminal, pendent, or in both locations.

Alkenyl groups may have 2 to 30, alternatively 2 to 24, alternatively 2 to 20, alternatively 2 to 12, alternatively 2 to 10, and alternatively 2 to 6 carbon atoms. Possible alkenyl groups are exemplified by, but not limited to, vinyl, allyl, methallyl, propenyl, and hexenyl and cyclohexenyl groups.

Alkynyl groups may have 2 to 30, alternatively 2 to 24, alternatively 2 to 20, alternatively 2 to 12, alternatively 2 to 10, and alternatively 2 to 6 carbon atoms. Alkynyl groups may be exemplified by, but not limited to, ethynyl, propynyl, and butynyl groups.

Component (a) of the liquid silicone rubber composition has multiple units of the formula (I):

R′ₐSiO_{(4-a)/2} (I)

in which each R′ is independently selected from an aliphatic hydrocarbyl, or aliphatic non-halogenated organyl group (that is any aliphatic organic substituent group, regardless of functional type, having one free valence at a carbon atom). Saturated aliphatic hydrocarbyls are exemplified by, but not limited to alkyl groups such as methyl, ethyl, propyl, pentyl, octyl, undecyl, and octadecyl and cycloalkyl groups such as cyclohexyl. Unsaturated aliphatic hydrocarbyls are exemplified by, but not limited to the alkenyl groups and alkynyl groups described above. The aliphatic non-halogenated organyl groups are exemplified by, but not limited to, suitable nitrogen containing groups such as amido groups, imido groups; oxygen containing groups such as polyoxyalkylene groups, carbonyl groups, alkoxy groups and hydroxyl groups. Further organyl groups may include phosphorus containing groups, boron containing groups. The subscript “a” is 0, 1, 2 or 3, typically in this instance a is mainly 2 but may contain some units where a is 1 or 3.

Siloxy units may be described by a shorthand (abbreviated) nomenclature, namely—“M,” “D,” “T,” and “Q”, when R′ is as described above, alternatively an alkyl group, typically a methyl group The M unit corresponds to a siloxy unit where a=3, that is R′₃SiO_{1/2}; the D unit corresponds to a siloxy unit where a=2, namely R′₂SiO_{2/2}; the T unit corresponds to a siloxy unit where a=1, namely R′₁SiO_{3/2}; the Q unit corresponds to a siloxy unit where a=0, namely SiO_{4/2}. The polyorganosiloxane, of component (a), is substantially linear but may contain a proportion of branching due to the presence of T units (as previously described) within the molecule, hence the average value of subscript a in structure (T) is about 2.

Examples of typical R′ groups on component (a) the one or more polyorganosiloxanes containing at least two unsaturated groups, selected from alkenyl groups and alkynyl groups, per molecule, include mainly alkyl groups, especially methyl and ethyl, alternatively methyl groups but may also include aryl groups and/or fluoroalkyl groups such as trifluoropropyl or perfluoroalkyl groups in addition to the required at least two unsaturated groups selected from alkenyl and/or alkynyl groups, typically alkenyl groups The groups may be in pendent position (on a D or T siloxy unit) or may be terminal (on an M siloxy unit).

Hence, the polymer chain of component (a) of the liquid silicone rubber composition may be selected from polydimethylsiloxanes, alkylmethylpolysiloxanes, alkylarylpolysiloxanes or copolymers thereof (where reference to alkyl means any suitable alkyl group, alternatively an alkyl group having two or more carbons) providing each component (a) polymer comprises at least two alkenyl and or alkynyl groups, typically at least two alkenyl groups. Such polymer chains may have any suitable terminal groups, for example, they may be trialkyl terminated, alkenyldialkyl terminated alkynyldialkyl terminated or may be terminated with any other suitable terminal group combination providing each polymer contains at least two unsaturated groups selected from alkenyl and alkynyl groups per molecule. In one embodiment the terminal groups of such a polymer don't comprise any silanol terminal groups.

Hence component (a) may, for the sake of example, be:
a dialkylalkenyl terminated polydimethylsiloxane, e.g., dimethylvinyl terminated polydimethylsiloxane; a dialkylalkenyl terminated dimethylmethylphenylsiloxane, e.g., dimethylvinyl terminated dimethylmethylphenylsiloxane; a trialkyl terminated dimethylmethylvinyl polysiloxane; a dialkylvinyl terminated dimethylmethylvinyl polysiloxane copolymer; a dialkylvinyl terminated methylphenylpolysiloxane, a dialkylalkenyl terminated methylvinylmethylphenylsiloxane; a dialkylalkenyl terminated methylvinyldiphenylsiloxane; a dialkylalkenyl terminated methylvinyl methylphenyl dimethylsiloxane; a trimethyl terminated methylvinyl methylphenylsiloxane; a trimethyl terminated methylvinyl diphenylsiloxane; or a trimethyl terminated methylvinyl methylphenyl dimethylsiloxane. More preferably comprising of phenylsilicone polymer between 0.5-5 wt. %

Component a) of the liquid silicone rubber composition has a viscosity of from 1000 mPa·s to 100,000 mPa·s at 25° C., alternatively 5000 mPa·s to 75,000 mPa·s at 25° C., 10,000 mPa·s to 60,000 mPa·s at 25° C. and is preferably present in an amount of from 25 to 60 wt. % of the composition, alternatively in an amount of from 30 to 60 wt. % of the composition, alternatively in an amount of from 35 to 55 wt. % of the composition. Unless otherwise indicated, viscosity may be measured at 25° C. using either a Brookfield™ rotational viscometer with spindle LV-4 for viscosities over 15,000 mPa·s (Spindle LV-4 designed for viscosities in the range between 1,000-2,000,000 mPa·s) at an appropriate rpm and using a Brookfield™ rotational viscometer with a cone plate arrangement with cone CP-52 for viscosities up to 15,000 mPa·s at 25° C. and an appropriate rpm.

### Component (b)

Component (b) of the liquid silicone rubber composition is a silica reinforcing filler which is optionally hydrophobically treated; The reinforcing fillers of component (b) may be exemplified by fumed silica and/or a precipitated silica and/or a colloidal silica. In one alternative, the fumed silica, precipitated silica and/or colloidal silica are provided in a finely divided form.

Precipitated silica, fumed silica and/or colloidal silicas are particularly preferred because of their relatively high surface area, especially when provided in a finely divided form, which is typically at least 50 m²/g (BET method in accordance with ISO 9277: 2010). Fillers having surface areas of from 50 to 450 m²/g (BET method in accordance with ISO 9277: 2010), alternatively of from 50 to 300 m²/g (BET method in accordance with ISO 9277: 2010), are typically used. All these types of silica are commercially available.

When silica reinforcing filler (b) is naturally hydrophilic (e.g., untreated silica fillers), it is typically treated with a treating agent to render it hydrophobic. These surface modified silica reinforcing fillers (b) do not clump and can be homogeneously incorporated into polydiorganosiloxane polymer (a), described below, as the surface treatment makes the fillers easily wetted by component (a).

Typically, silica reinforcing filler (b) of the liquid silicone rubber composition maybe surface treated with any low molecular weight organosilicon compounds disclosed in the art applicable to prevent creping of liquid silicone rubber (LSR) compositions during processing. For example, organosilanes, polydiorganosiloxanes, or organosilazanes e.g., hexaalkyl disilazane, short chain siloxane diols to render the silica reinforcing filler (b) hydrophobic and therefore easier to handle and obtain a homogeneous mixture with the other ingredients. Specific examples include, but are not restricted to, silanol terminated trifluoropropylmethylsiloxane, silanol terminated vinyl methyl (ViMe) siloxane, silanol terminated methyl phenyl (MePh) siloxane, liquid hydroxyldimethyl-terminated polydiorganosiloxane containing an average from 2 to 20 repeating units of diorganosiloxane in each molecule, hydroxyldimethyl terminated Phenylmethyl Siloxane, hexaorganodisiloxanes, such as hexamethyldisiloxane, divinyltetramethyldisiloxane; hexaorganodisilazanes, such as hexamethyldisilazane (HMDZ), divinyltetramethyldisilazane and tetramethyldi(trifluoropropyl)disilazane; hydroxyldimethyl terminated polydimethylmethylvinyl siloxane, octamethyl cyclotetrasiloxane, and silanes including but not limited to methyltrimethoxysilane, dimethyldimethoxysilane, vinyltrimethoxysilane, methyltriethoxysilane, vinyltriethoxysilane, chlorotrimethyl silane, dichlorodimethyl silane, trichloromethyl silane.

In one embodiment, the treating agent may be selected from silanol terminated vinyl methyl (ViMe) siloxane, liquid hydroxyldimethyl-terminated polydiorganosiloxane containing an average from 2 to 20 repeating units of diorganosiloxane in each molecule, hexaorganodisiloxanes, such as hexamethyldisiloxane, divinyltetramethyldisiloxane; hexaorganodisilazanes, such as hexamethyldisilazane (HMDZ), divinyltetramethyldisilazane and; hydroxyldimethyl terminated polydimethylmethylvinyl siloxane, octamethyl cyclotetrasiloxane, and silanes including but not limited to methyltriethoxysilane, dimethyldiethoxysilane and/or vinyltriethoxysilane. A small amount of water can be added together with the silica treating agent(s) as processing aid.

The surface treatment of untreated silica reinforcing filler (b) of the liquid silicone rubber composition may be undertaken prior to introduction in the composition or in situ (i.e., in the presence of at least a portion of the other ingredients of the composition herein by blending these ingredients together at room temperature or above until the filler is completely treated. Typically, untreated silica reinforcing filler (b) is treated in situ with a treating agent in the presence of component (a) which results in the preparation of a silicone rubber base material which can subsequently be mixed with other ingredients.

Silica reinforcing filler (b) of the liquid silicone rubber composition is optionally present in an amount of up to 40 wt. % of the composition, alternatively from 1.0 to 40 wt. % of the composition, alternatively of from 5.0 to 35 wt. % of the composition, alternatively of from 10.0 to 35 wt. % of the composition.

### Component (c1)

Component (c1) of the liquid silicone rubber composition is a hydrosilylation cure package comprising
(c1(i)) an organosilicon compound having at least two, alternatively at least three Si—H groups per molecule; and
(c1(ii)) a hydrosilylation catalyst comprising or consisting of a platinum group metal or a compound thereof;

Component (c1(i)) functions as a cross-linker and is provided in the form of an organosilicon compound having at least two, alternatively at least three Si—H groups per molecule. Component (c1(i)) of the liquid silicone rubber composition normally contains three or more silicon-bonded hydrogen atoms so that the hydrogen atoms can react with the unsaturated alkenyl and/or alkynyl groups of component (a) to form a network structure therewith and thereby cure the composition.

Some or all of Component (c1(i)) may alternatively have two silicon bonded hydrogen atoms per molecule when polymer (a) has greater than two unsaturated groups per molecule.

The molecular configuration of the organosilicon compound having at least two, alternatively at least three Si—H groups per molecule (c1(i)) is not specifically restricted. It may be a polyorganosiloxane which can have a straight chain, be branched (a straight chain with some branching through the presence of T groups), cyclic or be a silicone resin based.

While the molecular weight of component (c1(i)) is not specifically restricted, the viscosity is typically from 5 to 50,000 mPa·s at 25° C. using the test methodology as described for component (a).

Silicon-bonded organic groups used in component (c1(i)) may be exemplified by alkyl groups such as methyl, ethyl, propyl, n-butyl, t-butyl, pentyl, hexyl; aryl groups such as phenyl tolyl, xylyl, or similar aryl groups; 3-chloropropyl, 3,3,3-trifluoropropyl, or similar halogenated alkyl group, preferred alkyl groups having from 1 to 6 carbons, especially methyl ethyl or propyl groups or phenyl groups. Preferably the silicon-bonded organic groups used in component (c1(i)) are alkyl groups, alternatively methyl, ethyl or propyl groups.

Examples of the organosilicon compound having at least two, alternatively at least three Si—H groups per molecule (c1(i)) include but are not limited to:
(a′) trimethylsiloxy-terminated methylhydrogenpolysiloxane,
(b′) trimethylsiloxy-terminated polydimethylsiloxane-methylhydrogensiloxane,
(c′) dimethylhydrogensiloxy-terminated dimethylsiloxane-methylhydrogensiloxane copolymers,
(d′) dimethylsiloxane-methylhydrogensiloxane cyclic copolymers,
(e′) copolymers and/or silicon resins consisting of (CH₃)₂HsiO_{1/2} units, (CH₃)₃SiO_{1/2} units and SiO_{4/2} units,
(f′) copolymers and/or silicone resins consisting of (CH₃)₂HsiO_{1/2} units and SiO_{4/2} units,
(g′) Methylhydrogensiloxane cyclic homopolymers having between 3 and 10 silicon atoms per molecule;
alternatively, component (c1(i)), the cross-linker, may be a filler, e.g., silica treated with one of the above, and mixtures thereof.

In one embodiment the component (c1(i)) of the liquid silicone rubber composition is selected from a methylhydrogenpolysiloxane capped at both molecular terminals with trimethylsiloxy groups; a copolymer of a methylhydrogensiloxane and a dimethylsiloxane capped at both molecular terminals with trimethylsiloxy groups; dimethylsiloxane capped at both molecular terminals with dimethylhydrogensiloxy groups; a copolymer of a methylhydrogensiloxane and a dimethylsiloxane capped at both molecular terminals with dimethylhydrogensiloxy groups.

The cross-linker (c1(i)) is generally present in the liquid silicone rubber composition in an amount such that the molar ratio of the total number of the silicon-bonded hydrogen atoms in component (b) to the total number of alkenyl and/or alkynyl groups in component (a) is from 0.5:1 to 10:1. When this ratio is less than 0.5:1, a well-cured composition will not be obtained. When the ratio exceeds 10:1, there is a tendency for the hardness of the cured composition to increase when heated.

Preferably component (c1(i)) is in an amount such that the molar ratio of silicon-bonded hydrogen atoms of component (b) to alkenyl/alkynyl groups, alternatively alkenyl groups of component (a) ranges from 0.7:1.0 to a maximum of 5.0:1.0, alternatively from 0.9:1.0 to 2.5:1.0, and further alternatively from 0.9:1.0 to 2.0:1.0.

The silicon-bonded hydrogen (Si—H) content of component (c1(i)) is determined using quantitative infra-red analysis in accordance with ASTM E168. In the present instance the silicon-bonded hydrogen to alkenyl (vinyl) and/or alkynyl ratio is important when relying on a hydrosilylation cure process. Generally, this is determined by calculating the total weight % of alkenyl groups in the composition, e.g., vinyl [V] and the total weight % of silicon bonded hydrogen [H] in the composition and given the molecular weight of hydrogen is 1 and of vinyl is 27 the molar ratio of silicon bonded hydrogen to vinyl is 27[H]/[V].

Typically, dependent on the number of unsaturated groups in component (a) as well as the number of Si—H groups in component (c1(i)), component (c1(i)) will be present in an amount of from 0.1 to 10 wt. % of the hydrosilylation curable silicone rubber composition, alternatively 0.1 to 7.5 wt. % of the hydrosilylation curable silicone rubber composition, alternatively 0.5 to 7.5 wt. %, further alternatively from 0.5% to 5 wt. % of the hydrosilylation curable silicone rubber composition.

Component (c1(ii))

Component (c1(ii)) of the liquid silicone rubber composition is a hydrosilylation catalyst comprising or consisting of a platinum group metal or a compound thereof. These are usually selected from catalysts of the platinum group of metals (platinum, ruthenium, osmium, rhodium, iridium and palladium), or a compound of one or more of such metals. Alternatively, platinum and rhodium compounds are preferred due to the high activity level of these catalysts in hydrosilylation reactions, with platinum compounds most preferred. In a hydrosilylation (or addition) reaction a hydrosilylation catalyst such as component (c1(ii)) herein catalyses the reaction between an unsaturated group, usually an alkenyl group e.g., vinyl with Si—H groups.

The catalyst (c1(ii)) of the liquid silicone rubber composition can be a platinum group metal, a platinum group metal deposited on a carrier, such as activated carbon, metal oxides, such as aluminum oxide or silicon dioxide, silica gel or powdered charcoal, or a compound or complex of a platinum group metal.

Preferably the platinum group metal is platinum.

Examples of preferred hydrosilylation catalysts (c1(ii)) are platinum based catalysts, for example, platinum black, platinum oxide (Adams catalyst), platinum on various solid supports, chloroplatinic acids, e.g., hexachloroplatinic acid (Pt oxidation state IV) (Speier catalyst), chloroplatinic acid in solutions of alcohols e.g., isooctanol or amyl alcohol (Lamoreaux catalyst), and complexes of chloroplatinic acid with ethylenically unsaturated compounds such as olefins and organosiloxanes containing ethylenically unsaturated silicon-bonded hydrocarbon groups, e.g., tetra-vinyl-tetramethylcyclotetrasiloxane-platinum complex (Ashby catalyst). Soluble platinum compounds that can be used include, for example, the platinum-olefin complexes of the formulae (PtCl₂·(olefin)₂ and H(PtCl₃·olefin), preference being given in this context to the use of alkenes having 2 to 8 carbon atoms, such as ethylene, propylene, isomers of butene and of octene, or cycloalkanes having 5 to 7 carbon atoms, such as cyclopentene, cyclohexene, and cycloheptene. Other soluble platinum catalysts are, for the sake of example a platinum-cyclopropane complex of the formula (PtCl₂C3H₆)₂, the reaction products of hexachloroplatinic acid with alcohols, ethers, and aldehydes or mixtures thereof, or the reaction product of hexachloroplatinic acid and/or its conversion products with vinyl-containing siloxanes such as methylvinylcyclotetrasiloxane in the presence of sodium bicarbonate in ethanolic solution. Platinum catalysts with phosphorus and amine ligands can be used as well, e.g., (Ph₃P)₂PtCl₂; and complexes of platinum with vinylsiloxanes, such as sym-divinyltetramethyldisiloxane.

Hence, specific examples of suitable platinum-based catalysts include
(i) complexes of chloroplatinic acid with organosiloxanes containing ethylenically unsaturated hydrocarbon groups are described in U.S. Pat. No. 3,419,593;
(ii) chloroplatinic acid, either in hexahydrate form or anhydrous form;
(iii) a platinum-containing catalyst which is obtained by a method comprising reacting chloroplatinic acid with an aliphatically unsaturated organosilicon compound, such as divinyltetramethyldisiloxane; (iv) alkene-platinum-silyl complexes as described in U.S. Pat. No. 6,605,734 such as (COD)Pt(SiMeCl₂)₂ where “COD” is 1,5-cyclooctadiene; and/or
(v) Karstedt's catalyst, a platinum divinyl tetramethyl disiloxane complex typically containing about 1 wt. % of platinum typically in a vinyl siloxane polymer with a viscosity of from about 200 to 750 using the test methodology as described for component (a).

Solvents such as toluene and the like organic solvents have been used historically as alternatives but the use of vinyl siloxane polymers by far the preferred choice. These are described in U.S. Pat. Nos. 3,715,334 and 3,814,730. In one preferred embodiment component (c1(ii)) may be selected from co-ordination compounds of platinum. In one embodiment hexachloroplatinic acid and its conversion products with vinyl-containing siloxanes, Karstedt's catalysts and Speier catalysts are preferred.

Component (c1(ii)) of the liquid silicone rubber composition is typically present in a quantity of platinum atom that provides from 0.1 to 500 ppm (parts per million) with respect to the weight of the reactive ingredients, components (a) and (c1(ii)). The catalyst may be added as a single species or as a mixture of two or more different species. Typically, dependent on the form/concentration in which the catalyst (c1(ii)) is provided the amount of catalyst present will be within the range of from 0.05-1.5 wt. % of the composition, alternatively from 0.05-1.0 wt. %, alternatively from 0.1-1.0 wt. %, alternatively 0.1 to 0.5 wt. %, of the composition, wherein the platinum catalyst is provided in a masterbatch of polymer such as (a) described above.

### (d) Stabilizing Additive

Component (d) of the liquid silicone rubber composition is 0.25 wt. % to a maximum of 5.0 wt. % of the composition, alternatively 0.5 wt. % to 5 wt. % of the composition, 0.5 wt. % to 3 wt. % of the composition, alternatively 0.5 wt. % to 2 wt. % of the composition, alternatively 0.5 wt. % to 1.5 wt. % of the composition, alternatively 0.75 wt. % to 1.5 wt. % of the composition, of a stabilizing additive selected from the group consisting of one or more magnesium carbonates, one or more magnesium hydroxy carbonates, magnesium oxide, and a mixture thereof. Alternatively the stabilizing additive comprises one or more magnesium carbonates or magnesium hydroxy carbonates selected from magnesite (MgCO₃), barringtonite (MgCO₃·2H₂O), nesquihonite (MgCO₃·3H₂O), lansfordite (MgCO₃·5H₂O); and one or more magnesium hydroxy carbonates such as perovskite (Mg₂(CO₃)(OH)₂·5H₂O), artinite (Mg₂(CO₃)(OH)₂·3H₂O), hydromagnesite (Mg₅(CO₃)₄(OH)₂·4H₂O) which is sometimes referred to as light magnesium carbonate, dypingite (Mg₅(CO₃)₄(OH)₂·5H₂O) which is sometimes referred to as heavy magnesium carbonate, giorgiosite (Mg₅(CO₃)₄(OH)₂·5-6H₂O) and shelkovite (Mg₇(CO₃)₅(OH)₄·24H₂O).

### High Consistency Silicone Rubber Composition

In the case of a high consistency rubber composition components (b″), (c1″) and (d″) are the same as (b), (c1) and (d) respectively for the liquid silicone rubber composition described above, however, component (a″) is different and component (c2″) a free radical curative replaces component (c1″), wherein:
(a″) is chemically in accordance with component (a) of the LSR composition but contains the following differences, in that it has a much greater viscosity having a Williams plasticity of at least 100 mm/100 measured in accordance with ASTM D-926-08; and
the at least two unsaturated groups per molecule, which unsaturated groups are selected from alkenyl or alkynyl groups are essential when component (c1″) is being used as the catalyst package and is optional when component c is a free radical curative (c2″); and

Component (c2″) Component (c2″) a free radical curative of the high consistency rubber composition is selected from a suitable azo compound or an organic peroxide or a selection thereof. Any suitable peroxide catalysts may be utilised. Suitable organic peroxides include substituted or unsubstituted dialkyl-, alkylaroyl-, diaroyl-peroxides, e.g., benzoyl peroxide and 2,4-dichlorobenzoyl peroxide, ditertiarybutyl peroxide, dicumyl peroxide, t-butyl cumyl peroxide, Bis(tert-butyldioxy)diisopropylbenzene bis(t-butylperoxy)-2,5-dimethyl hexyne 2,4-dimethyl-2,5-di(t-butylperoxy) hexane, di-t-butyl peroxide and 2,5-bis(tert-butyl peroxy)-2,5-dimethylhexane. Mixtures of the above may also be used.

Typically, the amount of free radical curative (c2″) utilised in a high consistency rubber composition as described herein is from 0.2 to 3 wt. %, alternatively 0.2 to 2 wt. % in each case based on the weight of the composition.

### Optional Additives

In each case, i.e., irrespective of whether the composition is a liquid silicone rubber composition or a high consistency rubber composition, a variety of optional additives to suit the application for which the elastomer resulting from cure is to be used may also be incorporated into the composition.

Examples include cure inhibitors, mold releasing agents, non-reinforcing fillers, adhesion catalysts, electrically conductive fillers, thermally conductive fillers, pot life extenders, flame-retardants, lubricants, heat stabilisers, compression set additives, UV light stabilizers, bactericides, wetting agents and the like. When present said optional additives may function as more than one type of additive.

### Cure Inhibitors

Cure inhibitors are used, when required, in hydrosilylation (addition) cure systems e.g., when the composition comprises components Cl, to prevent or delay the addition-reaction curing process especially during storage. The optional addition-reaction inhibitors of platinum-based catalysts are well known in the art and include hydrazines, triazoles, phosphines, mercaptans, organic nitrogen compounds, acetylenic alcohols, silylated acetylenic alcohols, maleates, fumarates, ethylenically or aromatically unsaturated amides, ethylenically unsaturated isocyanates, olefinic siloxanes, unsaturated hydrocarbon monoesters and diesters, conjugated ene-ynes, hydroperoxides, nitriles, and diaziridines. Alkenyl-substituted siloxanes as described in U.S. Pat. No. 3,989,667 may be used, of which cyclic methylvinylsiloxanes are preferred.

One class of known hydrosilylation reaction inhibitors are the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-butyn-2-ol, propargyl alcohol, 1-phenyl-2-propyn-1-ol, 3,5-dimethyl-1-hexyn-3-ol, 1-ethynylcyclopentanol, 3-methyl-1-penten-4-yn-3-ol, and mixtures thereof.

Derivatives of acetylenic alcohol may include those compounds having at least one silicon atom. When present, inhibitor concentrations as low as 1 mole of inhibitor per mole of the metal of catalyst will in some instances impart satisfactory storage stability and cure rate. In other instances, inhibitor concentrations of up to 500 moles of inhibitor per mole of the metal of catalyst are required. The optimum concentration for a given inhibitor in a given composition is readily determined by routine experimentation. Dependent on the concentration and form in which the inhibitor selected is provided/available commercially, when present in the composition, the inhibitor is typically present in an amount of from 0.0125 to 10% by weight of the composition.

In one embodiment the inhibitor when present is selected from 1-ethynyl-1-cyclohexanol (ETCH) and/or 2-methyl-3-butyn-2-ol and is present in an amount of greater than zero to 0.1% by weight of the composition.

### Mold Release Agent

Any suitable mold release agent may be utilised. It may, for example, be a hydroxydimethyl terminated polydimethylsiloxane having viscosity of approximately 21 mPa·s at 25° C. measured using a Brookfield™ rotational viscometer with a cone plate arrangement with cone CP-52 at 12 rpm.

### Non-Reinforcing Fillers

Non-reinforcing fillers may include such as crushed quartz, diatomaceous earths, barium sulphate, iron oxide, titanium dioxide and carbon black, talc, wollastonite. Other fillers which might be used alone or in addition to the above include aluminite, calcium sulphate (anhydrite), gypsum, calcium sulphate, clays such as kaolin, aluminium trihydroxide, graphite, copper carbonate, e.g., malachite, nickel carbonate, e.g., zarachite, barium carbonate, e.g., witherite and/or strontium carbonate e.g., strontianite.

Other fillers may include, aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅; mullite; 3Al₂O₃·2SiO₂; kyanite; and Al₂SiO₅. Ring silicates may be utilised as non-reinforcing fillers, these include silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃]. Sheet silicates may alternatively or additionally be used as non-reinforcing fillers where appropriate group comprises silicate minerals, such as but not limited to, mica; K₂Al₁₄[Si₆Al₂O₂₀](OH)₄; pyrophyllite; Al₄[Si₈O₂₀](OH)₄; talc; Mg₆[Si₈O₂₀](OH)₄; serpentine for example, asbestos; Kaolinite; Al₄[Si₄O₁₀](OH)₈; and vermiculite. For the avoidance of doubt component (d) is not considered a non-reinforcing filler.

Further additives include silicone fluids, such as trimethylsilyl or OH terminated siloxanes. Such trimethylsiloxy or OH terminated polydimethylsiloxanes typically have a viscosity<150 mPa·s at 25° C. measured using a measured using a Brookfield™ rotational viscometer with a cone plate arrangement with cone CP-52 at 12 rpm. When present such silicone fluid may be present in the liquid curable silicone rubber composition in an amount ranging of from 0.1 to 5% by weight (wt. %), based on the total weight of the composition and may function as mold release agents.

### Pigments and Other Colourants

Examples of pigments include titanium dioxide, chromium oxide, bismuth vanadium oxide, iron oxides and mixtures thereof.

Examples of colouring agents for which may be utilised in the hydrosilylation curable silicone coating composition include pigments, vat dyes, reactive dyes, acid dyes, chrome dyes, disperse dyes, cationic dyes and mixtures thereof. The two-part moisture cure organopolysiloxane composition as described herein may further comprise one or more pigments and/or colorants which may be added if desired. The pigments and/or colorants may be coloured, white, black, metal effect, and luminescent e.g., fluorescent and phosphorescent. Pigments are utilized to colour the composition as required. Any suitable pigment may be utilized providing it is compatible with the composition herein. In two-part moisture cure organopolysiloxane compositions pigments and/or coloured (non-white) fillers e.g., carbon black may be utilized in the catalyst package to colour the end sealant product.

Suitable white pigments and/or colorants include titanium dioxide, zinc oxide, lead oxide, zinc sulfide, lithophone, zirconium oxide, and antimony oxide.

Suitable non-white inorganic pigments and/or colorants include, but are not limited to, iron oxide pigments such as goethite, lepidocrocite, hematite, maghemite, and magnetite black iron oxide, yellow iron oxide, brown iron oxide, and red iron oxide; blue iron pigments; chromium oxide pigments; cadmium pigments such as cadmium yellow, cadmium red, and cadmium cinnabar; bismuth pigments such as bismuth vanadate and bismuth vanadate molybdate; mixed metal oxide pigments such as cobalt titanate green; chromate and molybdate pigments such as chromium yellow, molybdate red, and molybdate orange; ultramarine pigments; cobalt oxide pigments; nickel antimony titanates; lead chrome; carbon black; lampblack, and metal effect pigments such as aluminium, copper, copper oxide, bronze, stainless steel, nickel, zinc, and brass.

Suitable organic non-white pigments and/or colorants include phthalocyanine pigments, e.g., phthalocyanine blue and phthalocyanine green; monoarylide yellow, diarylide yellow, benzimidazolone yellow, heterocyclic yellow, DAN orange, quinacridone pigments, e.g., quinacridone magenta and quinacridone violet; organic reds, including metallized azo reds and nonmetallized azo reds and other azo pigments, monoazo pigments, diazo pigments, azo pigment lakes, β-naphthol pigments, naphthol AS pigments, benzimidazolone pigments, diazo condensation pigment, isoindolinone, and isoindoline pigments, polycyclic pigments, perylene and perinone pigments, thioindigo pigments, anthrapyrimidone pigments, flavanthrone pigments, anthanthrone pigments, dioxazine pigments, triarylcarbonium pigments, quinophthalone pigments, and diketopyrrolo pyrrole pigments.

Typically, the pigments and/or colorants, when particulates, have average particle diameters in the range of from 10 nm to 50 μm, preferably in the range of from 40 nm to 2 μm.

### Lubricants

As previously indicated compositions of the sort described herein are often utilised as electrical or electronic connectors. Often such electrical or electronic connectors are made from self-lubricating silicone elastomers which are designed to gradually exude over time from the cured seals and lubricate cable and connector assemblies. Typically, polyphenylmethylsiloxanes and copolymers thereof such as trimethylsilyl terminated phenylmethylsiloxane dimethylsiloxane copolymers having a viscosity of from 100 mPa·s to 200 mPa·s at 25° C. using a Brookfield™ rotational viscometer with a cone plate arrangement with cone CP-52 at 12 rpm and mixtures or derivatives thereof. are used as the lubricants in such situations. Examples of other lubricants which might be alternatively or additionally utilised include tetrafluoroethylene, resin powder, graphite, fluorinated graphite, talc, boron nitride, fluorine oil, molybdenum disulfide, and mixtures or derivatives thereof.

When present such lubricants may be present in an amount of from 1 to 7 wt. % of the composition.

### Heat Stabilisers

The composition herein may also comprise one or more inorganic heat stabilizers, such as hydrated cerium oxide, cerium hydroxide, cerium carboxylates and/or cerium esters, e.g., cerium ethylhexanoate, hydrated aluminum oxide, red iron oxide, yellow iron oxide, carbon black, graphite and zinc oxide used alone or in combination.

### Metal Deactivators

The composition may incorporate one or more metal deactivators selected from a diacylhydrazide-based compound, an aminotriazole-based compound, and an amino-containing triazine-based compound. Alternatively, the metal deactivator has a molecular weight of 120 to 700 and is an amino group-containing triazine compound or a compound having a phenol group in the backbone and an amide bond. Typically, the metal deactivator has a melting point of 80° C. or more, and 300° C. or less, wherein the melting point is measured by means of a differential scanning calorimetry (DSC). The melting point can be measured by a differential scanning calorimeter (DSC) according to JIS K 7121-1978 “Testing Methods for Transition Temperatures of Plastics.” In this apparatus, a pan for DSC measurement in which a polyester resin (A) sample was sealed was set, heated to 320° C. at a heating rate of 10° C./min in a nitrogen atmosphere, and held at that temperature for 5 minutes. The temperature is decreased to 30° C. by measuring the temperature decrease at 10° C./min. The temperature at the top of the endothermic peak at the time of temperature rise is defined as the “melting point.”

The diacylhydrazide-based compound is represented by the following general formula:

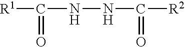

where R¹ and R² may be the same or different and may be represented by hydrogen atoms, hydroxyl groups, alkyl groups, substituted alkyl groups, aryl groups, phenol groups or similar substituted aryl groups, aralkyl groups, or substituted aralkyl groups. It is preferable that R¹ and R² comprise monovalent hydrocarbon groups that contain aryl groups, a phenol or a similar substituted aryl group. Specific examples of the aforementioned diacylhydrazide-based compounds are the following: N,N′-diformyl hydrazine, N,N′-diacetyl hydrazine, N,N′-dipropionyl hydrazine, N,N′-butylyl hydrazine, N-formyl-N′-acetyl hydrazine, N,N′-dibenzoyl hydrazine, N,N′-ditolyoyl hydrazine, N,N′-disalicyloyl hydrazine, N-formyl-N′-disalicyloyl hydrazine, N-formyl-N′-butyl-substituted salicyloyl hydrazine, N-acetyl-N′-salicyloyl hydrazine, N,N′-bis [3-(3,5-di-t-butyl-4-hydroxyphenyl) propyonyl]hydrazine, adipic acid di-(N′-salicyloyl) hydrazine, or dodecane dioyl-di-(N′-salicyloyl) hydrazine.

Commercially produced compounds of the aforementioned include, for the sake of example are N,N′-bis-[3-(3,5-di-t-butyl-4-hydroxyphenyl) propionyl]hydrazine), sold as Irganox™ MD1024 from BASF, dodecanedioyl-di-(N′-salicyloyl)hydrazine, a synonym for which is 1-N′,12-N′-bis(2-hydroxybenzoyl)dodecanedihydrazide, which is sold commercially as ADK STAB™ CDA-6 from Adeka Corporation (referred to hereafter as CDA-6); N′1,N′12-Bis(2-hydroxybenzoyl)dodecanedihydrazide which is sold commercially as ADK STAB™ CDA-6S from Adeka Corporation, and N,N′-Bis[3-(3,5-di-tert-buty-4-hydroxyphenyl)propionyl]hydrazine which is sold commercially as ADK STAB™ CDA-10 from Adeka Corporation, and N,N′-bis-3-(3,5-di-tert-butyl-4-hydroxyphenyl) propionylhexamethylenediamine which is sold commercially as ANTAGE HP-300 from Kawaguchi Chemical Industry.

The aminotriazole-based compound is expressed by the following general formula (2):

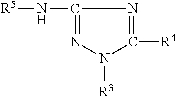

where R⁴ and R⁵ are the same or different and are represented by hydrogen atoms, alkyl groups, substituted alkyl groups, substituted aryl groups, carboxyl groups, acyl groups, alkyl-ester groups, aryl-ester groups, halogens, or alkali metals; R³ may represent a hydrogen atom or an acyl group; R⁵ may be an acyl group, preferably, a salicyloyl group, benzoyl group, or a similar acyl group having an aromatic ring. Examples of the aforementioned compounds may include 3-amino-1,2,4-triazole, 3-amino-1,2,4-triazole-carboxylic acid, 3-amino-5-methyl-1,2,4-triazol, 3-amino-5-heptyl-1,2,4-triazol, etc.; or an acid amide derivative of an amino-triazole-based compound where the hydrogen atoms of a triazole-bonded amino groups are substituted with acyl groups, e.g., 3-(N-salicyloyl) amino-1,2,4-triazole or 3-(N-acetyl) amino-1,2,4-triazol-5-carboxylic acid. Most preferable among the above compounds is the acid amide derivative of the aminotriazole-based compound since this compound does not delay speed of curing of the addition-reaction-curable silicone rubber composition.

An example of a commercially produced compound of this type is 3-(n-Salicyloyl)Amino-1,2,4-Triazole (a synonym for which is 2-Hydroxy-N-1H-1,2,4-triazol-3-ylbenzamide) which is sold commercially as ADK STAB™ CDA-1 and in a blend as ADK STAB CDA-1M from Adeka Corporation. A further commercial example is Adekastab™ ZS-27 from Adeka Corporation the main component of which is understood to be 2,4,6-triamino-1,3,5-triazine.

In one alternative component (e) (ii) is dodcadioyl-di-(N′-salicyloyl) hydrazine or 3-(N-salicyloyl) amino-1,2,4-triazole.

When present, component (e) (ii) is added in an amount of 0.001 to 1.0 wt. % of the composition, alternatively an amount of 0.001 to 0.5 wt. % of the composition, alternatively in an amount of 0.01 to 0.5 wt. % of the composition, alternatively in an amount of 0.05 to 0.5 wt. % of the composition.

In one embodiment the composition contains a metal deactivator as described above.

Hence, the liquid silicone rubber composition utilised to produce the silicone elastomers herein may comprise any suitable combination of the following components:
a) one or more polyorganosiloxanes containing at least two unsaturated groups, selected from alkenyl groups and alkynyl groups, per molecule and having a viscosity in a range of from 1000 mPa·s to 100,000 mPa·s at 25° C.; alternatively 5000 mPa·s to 75,000 mPa·s at 25° C., 10,000 mPa·s to 60,000 mPa·s at 25° C., an is preferably present in an amount of from 25 to 60 wt. % of the composition, alternatively in an amount of from 30 to 60 wt. % of the composition, alternatively in an amount of from 35 to 55 wt. % of the composition. Viscosity may be measured at 25° C. as described above;
b) a silica reinforcing filler which is preferably in a finely divided form and is optionally hydrophobically treated; high surface area, which is typically at least 50 m²/g (BET method in accordance with ISO 9277: 2010). Silica reinforcing filler (c) s having surface areas of from 50 to 450 m²/g (BET method in accordance with ISO 9277: 2010), alternatively of from 50 to 300 m²/g (BET method in accordance with ISO 9277: 2010) and are typically present in an amount of up to 40 wt. % of the composition, alternatively from 1.0 to 40 wt. % of the composition, alternatively of from 5.0 to 35 wt. % of the composition, alternatively of from 10.0 to 35 wt. % of the composition;

Component (c1) of the liquid silicone rubber composition is a hydrosilylation cure package comprising
(c1(i)) an organosilicon compound having at least two, alternatively at least three Si—H groups per molecule; and
(c1(ii)) a hydrosilylation catalyst comprising or consisting of a platinum group metal or a compound thereof;

The organosilicon compound having at least two, alternatively at least three Si—H groups per molecule (c1(i)) as hereinbefore described, may be present in an amount of from 0.1 to 10 wt. % of the liquid silicone rubber composition, alternatively 0.1 to 7.5 wt. % of the hydrosilylation curable silicone rubber composition, alternatively 0.5 to 7.5 wt. %, further alternatively from 0.5% to 5 wt. % of the composition;

Component (c1(ii)) of the liquid silicone rubber composition is a hydrosilylation catalyst comprising or consisting of a platinum group metal or a compound thereof as hereinbefore described; in an amount dependent on the form/concentration in which the catalyst is provided, within the range of from 0.001 to 3.0 wt. % of the composition, alternatively from 0.001 to 1.5 wt. % of the composition, alternatively from 0.01-1.5 wt. %, alternatively 0.01 to 0.1.0 wt. %, of the silicone rubber composition,
Component (d) is 0.25 wt. % to a maximum of 5.0 wt. % of a stabilizing additive selected from the group consisting of magnesium carbonates, magnesium hydroxy carbonates, magnesium oxide, and a mixture thereof;
   providing the total wt. % of the composition is 100 wt. %.

The composition may also contain one or more of the above optional additives in amounts indicated again providing the total wt. % of the composition is 100 wt. %.

Hence, the high consistency rubber composition which may be utilised to produce the silicone elastomers herein may comprise any suitable combination of the following components:
a″) one or more polyorganosiloxanes having a Williams plasticity of at least 100 mm/100 in accordance with ASTM D-926-08 wherein when hydrosilylation curable polymer a″ must also contain at least two unsaturated groups, selected from alkenyl groups and alkynyl groups whilst when the high consistency rubber composition is free-radical cured the at least two unsaturated groups, selected from alkenyl groups and alkynyl groups are optional in polymer a″; which component a″ is preferably present in an amount of from 25 to 60 wt. % of the composition, alternatively in an amount of from 30 to 60 wt. % of the composition, alternatively in an amount of from 35 to 55 wt. % of the composition.
b″) a silica reinforcing filler which is the same as component (b) above with respect to the liquid silicone rubber composition;

Component (c1″) of the high consistency rubber is a hydrosilylation cure package and is used when the high consistency rubber is a hydrosilylation (addition) curable composition ed and has the same composition and amounts as component (c1) for the liquid silicone rubber composition above; position,
Component c2″ a free radical curative of the high consistency rubber composition is selected from a suitable azo compound or an organic peroxide or a selection thereof; in an amount of free radical curative (c2″) utilised in a high consistency rubber composition as described herein is from 0.2 to 3 wt. %, alternatively 0.2 to 2 wt. % in each case based on the weight of the composition;

Again, component (d) is 0.25 wt. % to a maximum of 5.0 wt. %, alternatively 0.5 wt. % to 5 wt. %, alternatively 0.5 wt. % to 3 wt. %, alternatively 0.5 wt. % to 2 wt. %, alternatively 0.5 wt. % to 1.5 wt. %, alternatively 0.75 wt. % to 1.5 wt. % of a stabilizing additive selected from the group consisting of one or more magnesium carbonates, one or more magnesium hydroxy carbonates, magnesium oxide, and a mixture thereof;
providing the total wt. % of the composition is 100 wt. %.

The composition may also contain one or more of the above optional additives in amounts indicated again providing the total wt. % of the composition is 100 wt. %.

When the silicone elastomers used herein are prepared from liquid silicone rubber compositions as hereinbefore described such compositions are hydrosilylation curable and are usually stored before use in two or more parts. In the case of a two-part composition, the two parts are usually referred to as part (A) and part (B):
Part (A) typically contains the catalyst (c1(ii)) in addition to polyorganosiloxane (a) and silica reinforcing filler (b) when present, and
Part (B) usually includes cross-linker component (c1(ii)) and when present optional inhibitor as well as remaining polyorganosiloxane (a) and/or the silica reinforcing filler (b).

It is important for the catalyst (c1(ii)) to be stored separately from cross-linker (c1(ii)) to prevent premature cure during storage.

Components (d), the 0.25 wt. % to a maximum of 5.0 wt. % of stabilizing additive is selected from the group consisting of magnesium carbonates, magnesium hydroxy carbonates, magnesium oxide, and a mixture thereof. It may be stored in either part (A) or part (B) or in both parts providing they do not negatively affect the storage of any of the essential ingredients present in the respective part. Alternatively, if desired component (d) may be added into the remaining composition i.e., to the combination of the part (A) and part (B) compositions during or after the part (A) composition and the part (B) compositions are mixed together prior to use.

Any optional additives, other than the inhibitor described above, may be incorporated into either part (A) or part (B) or in both parts providing they do not negatively affect the storage of any of the essential ingredients present in the respective part.

The compositions can be designed to be mixed in any suitable ratio e.g., part (A): part (B) may be mixed together in weight ratios of from 10:1 to 1:10, alternatively from 5:1 to 1:5, alternatively from 2:1 to 1:2, but most preferred is a weight ratio of 1:1.

Ingredients/components in each of Part (A) and/or Part (B) may be mixed together individually in their respective part or may be introduced into the composition in pre-prepared in combinations for, e.g., ease of mixing the final composition. For Example, components (a) and (b) are often mixed together to form an LSR polymer base or masterbatch prior to introduction of other ingredients. These may then be mixed with the other ingredients of the Part being made directly or may be used to make pre-prepared concentrates commonly referred to in the industry as masterbatches.

In this instance, for ease of mixing ingredients, one or more masterbatches may be utilized to successfully mix the ingredients to form Part (A) and/or Part (B) compositions. For example, a “fumed silica” masterbatch may be prepared. This is effectively an LSR silicone rubber base with the silica reinforcing filler (c) treated in situ.

Parts A and B of the composition may be prepared by combining all of their respective components at ambient temperature. Any mixing techniques and devices described in the prior art can be used for this purpose. The particular device to be used will be determined by the viscosities of components and the final composition. A suitable mixer may include but are not limited to kneader mixer, a static mixer in a liquid injection molding machine, a Z-blade mixer, a two-roll mill (open mill), a three-roll mill, a Haake™ Rheomix OS Lab mixer, a screw extruder or a twin-screw extruder or the like. Speed mixers as sold by e.g., Hauschild and as DC 150.1 FV, DAC 400 FVZ or DAC 600 FVZ, may alternatively be used. Cooling of components during mixing may be desirable to avoid premature curing of the composition.

The part (A) and part (B) compositions can be designed to be mixed in any suitable weight ratio e.g., part (A):part (B) may be mixed together in weight ratios of from 10:1 to 1:10, alternatively from 5:1 to 1:5, alternatively from 2:1 to 1:2, but most preferred is a weight ratio of 1:1.

Prior to use the respective Part (A) and Part (B) compositions are mixed together in the desired ratio.

Curing of the hydrosilylation curable silicone rubber composition on the substrate can, for example, take place in a mold to form a molded part, by injection molding, using e.g., a Liquid injection molding system (LIMS) press moulding, extrusion moulding, transfer moulding, press vulcanization, or calendaring.

In the case of a process for the manufacture of a two-part silicone rubber composition as hereinbefore described the process may comprise the steps
(i) preparation of a silicone base composition comprising components (a) polymer and (c) silica reinforcing filler,
(ii) dividing the resulting base into two parts, part (A) and part (B) and introducing the catalyst (d) into part (A) and the cross-linker (b) and inhibitor (if present) in the part (B) composition.
(iii) Introducing the other components any other optional additives into either or both part (A) and part (B); and
(iv) Storing the part (A) and part (B) compositions separately.

Typically, when utilised the part (A) and part (B) compositions are thoroughly mixed in a suitable weight ratio as described above, immediately before use in order to avoid premature cure. The curing stage cure is then undertaken. The hydrosilylation curable silicone rubber composition is cured at any suitable temperature e.g., at a temperature of from 80° C. to 200° C., alternatively from about 100° C. to 180° C., alternatively from about 120° C. to 180° C. As indicated above one of the standard ways of reducing compression set historically has been post curing with a view to reducing the number curable groups which might cure under compression during use as gaskets.

The hydrosilylation curable high consistency rubber option may be prepared in an analogous fashion as the above if desired. However, given component (a″) is a silicone gum having a having a Williams plasticity of at least 100 mm/100 in accordance with ASTM D-926-08 generally the composition is prepared by combining all of components together at ambient temperature into a one-part composition in cases where the composition is to be used immediately. Typically, a base is prepared first to enable the reinforcing silica fillers (b″) to be treated in-situ with a hydrophobing treating agent simultaneously with the mixing of the polymer and filler and any other additional treating agents when additionally present and then the remaining ingredients can be introduced into the mixture in any suitable order.

Any mixing techniques and devices described in the prior art can be used for this purpose. The particular device to be used will be determined by the viscosities of components and the final curable coating composition. Suitable mixers include but are not limited to paddle type mixers e.g., planetary mixers and kneader type mixers. However, when component (a″) is a gum mixing is preferably undertaken, as previously indicated using a kneader mixer. Cooling of components during mixing may be desirable to avoid premature curing of the composition.

There is also a process described herein for the preparation of a high consistency silicone rubber elastomer comprising the steps of
(i) preparing a silicone rubber base composition comprising components (a), (b) and (c) as hereinbefore described,
(ii) mixing into the silicone rubber base of step (i) components (d), (e) and simultaneously or subsequently component (f); and
(iii) curing the composition.

Step (i) may be achieved by mixing together components polymer (a″) and filler (b″) together with treating agent at a temperature in the range of from 80° C. to 250° C., alternatively from 100° C. to 220° C., alternatively 120° C. to 200° C. for a period of from 30 minutes to 2 hours, alternatively 40 minutes to 2 hours, alternatively of from 45 minutes to 90 minutes, to ensure the reinforcing silica filler is in-situ treated with the hydrophobing treating agent and they are all thoroughly mixed into component (a″). The resulting base may then be cooled to approximately room temperature (23° C. to 25° C.).

The remaining components may then be simultaneously or subsequently added as well as optional inhibitor (e.g., Ethynyl Cyclohexanol (ETCH)) and any other optional additives in any suitable order, or simultaneously and mixing to homogeneity.

Once prepared because of the reactivity of the polymer, hydrosilylation cross-linker and hydrosilylation catalyst the composition will cure. Typically, cure will take place at a temperature between 80° C. and 180° C., alternatively between 100° C. and 170° C., alternatively between 120° C. and 170° C. This may take place in any suitable manner for example, the composition may be introduced into a mold and is then press cured for a suitable period of time, e.g., from 2 to 10 minutes or as otherwise desired or required. The present hydrosilylation curable heat stabilised silicone rubber composition may alternatively be further processed by injection moulding, encapsulation moulding, press moulding, dispenser moulding, extrusion moulding, transfer moulding, press vulcanization, centrifugal casting, calendaring, bead application or blow moulding.

As and when required samples may be additionally post-cured by heating to a temperature of 130° C. to 200° C. for up to 4 hours.

Once prepared the silicone elastomeric article can be placed in its functional position on and/or around the thermoplastic article to provide a final silicone-thermoplastic composite article.

Subsequently the silicone-thermoplastic composite article is placed/fitted in position for use as and when required as part of a manufacturing process or the like.

The silicone-thermoplastic composite articles may be used for a wide range of applications in industrial situations, the home and increasingly in automobiles. In automotive applications they may be used as battery components, in charging components and powertrain components for electric vehicles, and in noise and vibration applications but are particularly well-known for being the rigid housing components for electrical or electronic connector housings used to create closed electrical circuits in automotive, residential, and infrastructural settings.

They are also utilised in a wide range of electrical and/or insulative applications e.g., for cable accessories such as electrical or electronic connectors, terminations and wire seals. Electrical or electronic connectors are commonly used to create closed electrical circuits in automotive, residential, and infrastructural settings due to their excellent balance of mechanical properties, chemical and thermal stabilities, processing ease, and availability of self-lubricating formulations.

They may be used to mate rigid thermoplastic housing components to provide both electrical and environmental isolation to the connector junctions from, for example, the potential presence of moisture, oils and fuels, and corrosive gases. The silicone elastomers made using the compositions herein have a suitably low compression set at high temperatures to provide mechanical integrity and dimensional stability for electrical or electronic connectors etc. as described above to provide excellent sealing performance during service life. Hence, they are used in or for the manufacture of automotive parts, cable accessories; electrical and electronic parts; packaging parts; construction parts such as sealants; household parts. In one embodiment the cable accessory is an electrical or electronic connector having a silicone elastomer seal.

The following examples are intended to illustrate and not to limit the disclosure herein.

### EXAMPLES

All viscosities were measured at 25° C. unless otherwise indicated. Viscosities of individual components in the following examples were measured using a Brookfield™ rotational viscometer with spindle LV-4 for viscosities over 15,000 mPa·s (Spindle LV-4 designed for viscosities in the range between 1,000-2,000,000 mPa·s) at an appropriate rpm and using a Brookfield™ rotational viscometer with a cone plate arrangement with cone CP-52 for viscosities up to 15,000 mPa·s at an appropriate rpm unless otherwise indicated.

The stability of physical properties caused by the introduction of the stabilising additive herein is exemplified by assessing the change in compression set in the following examples which it is believed is caused by the stabilising additive negating the debilitating effect on the silicone elastomers tested by flame retardants migrating therein from the thermoplastics. The compression results provided were undertaken in accordance with industrial standard norm ASTM D395-18 method B in which a cylindrical disc of diameter 29.0 mm±0.5 mm and thickness 12.5 mm±0.5 mm was compressed by 25% to about 9.38 mm thickness. Under compression, the silicone elastomer buttons were sandwiched on both top and bottom with a substrate (metal or plastic) and placed in the normal compression fixture. When needed, a thin metal shim plate was used to adjust for variability of substrate thickness. Unless otherwise indicated samples were placed in a convection oven at 25% compression at an oven temperature set to specified conditions.

Subsequently, compression was released and the test pieces were allowed to recover for 30 min prior to taking compression set measurements. A series of 2-part liquid silicone rubber elastomer and peroxide cured silicone rubber compositions were prepared as indicated in Tables 1a, 2a, 4, and 5 below.

The following components are referred to where pertinent in the compositions used:—

Fumed Silica 1: Treated fumed silica in the form of dimethylvinylated and trimethylated treated fumed silica having a BET surface area of approximately 250 m²/g (untreated).

Fumed Silica 2: Treated fumed silica in the form of dimethylvinylated and trimethylated treated fumed silica having a BET surface area of approximately 400 m²/g (untreated).

Fumed silica 3: Hydrophilic fumed silica with a specific surface area of 200 m2/g.

Precipitated silica: Precipitated silica from Tosoh Silica Corporation.

Polymer 1: vinyldimethyl terminated polydimethylsiloxane having a viscosity of 53,000 mPa·s at 25° C. measured using a Brookfield™ rotational viscometer with spindle LV-4 at 6 rpm Polymer 2: vinyl terminal poly(dimethylsiloxane-co-methylvinylsiloxane) having a viscosity of 370 mPa·s at 25° C. using a Brookfield™ rotational viscometer with a cone plate arrangement with cone CP-52 at 12 rpm.

Silica Masterbatch 1: dispersion of 66.6 wt. % dimethylvinylsiloxy-terminated polydimethylsiloxane having a viscosity of about 53,000 mPa·s at 25° C. with a total vinyl content of 0.17 wt % and 33.4 wt % of dimethylvinylated and trimethylated treated fumed silica having a BET surface area of approximately 250 m²/g (untreated).

Silica Masterbatch 2: dispersion of 70.8 wt. % dimethylvinylsiloxy-terminated polydimethylsiloxane having a viscosity of about 53,000 mPa·s at 25° C. with a total vinyl content of 0.062 wt. % and 29.2 wt. % of trimethylated treated fumed silica having a BET surface area of approximately 250 m²/g (untreated).

Silicone Gum 1: Dimethyl, methylvinyl, hydroxy-terminated siloxane gum having a Williams plasticity of 160 mm/100 and a vinyl content of 1.37 wt. %.

Silicone Gum 2: Dimethylvinyl-terminated, dimethyl, methylvinyl siloxane gum having a Williams plasticity of 155 mm/100 and a vinyl content of 0.06 wt. %.

Silicone Gum 3: Dimethyl vinyl-terminated dimethyl siloxane gum having a having a Williams plasticity of 154 mm/100 and a vinyl content of 0.01 wt. %.

Crosslinker 1: trimethyl terminated polymethylhydrogen dimethylsiloxane having a viscosity of 30 mPa·s at 25° C. using a Brookfield™ rotational viscometer with a cone plate arrangement with cone CP-52 at 12 rpm.

Crosslinker 2: Dimethyl, methylhydrogen siloxane with methyl silsesquioxane having a viscosity of 15 mPa·s at 25° C. using a Brookfield™ rotational viscometer with a cone plate arrangement with cone CP-52 at 12 rpm.

Inhibitor: 1-Ethynyl-cyclohexanol (ETCH).

Peroxide catalyst: 2,5-Dimethyl-2,5-di (t-butylperoxy) hexane.

Additive 1: tetravinyl-tetramethyl-cyclotetrasiloxane.

Additive 2: hydroxydimethyl terminated polydimethylsiloxane having viscosity of approximately 21 mPa·s at 25° C. measured using a Brookfield™ rotational viscometer with spindle LV-2 at 12 rpm Additive 3: trimethylsilyl terminated phenylmethylsiloxane dimethylsiloxane copolymer having a viscosity of 125 mPa·s at 25° C. using a Brookfield™ rotational viscometer with a cone plate arrangement with cone CP-52 at 12 rpm.

Additive 4: dodecanedioyl-di-(N′-salicyloyl)hydrazine, a synonym for which is 1-N′,12-N′-bis(2-hydroxybenzoyl)dodecanedihydrazide, which is sold commercially as ADK STAB™ CDA-6 from Adeka Corporation.

Additive 5: Hydroxydimethyl terminated polydimethylsiloxane having viscosity of approximately 42 mPa·s at 25° C. using a Brookfield™ rotational viscometer with a cone plate arrangement with cone CP-52 at 12 rpm.

Additive 6: Dimethyl methylvinyl hydroxy-terminated siloxane having viscosity of approximately 23 mPa·s at 25° C. using a Brookfield™ rotational viscometer with a cone plate arrangement with cone CP-52 at 12 rpm.

Additive 7: Methyl phenyl, hydroxy-terminated siloxane of approximately 500 mPa·s at 25° C. using a Brookfield™ rotational viscometer with a cone plate arrangement with cone CP-52 at 12 rpm.

Additive 8: Dispersion of 60 wt. % of dimethylvinyl-terminated, dimethyl, methylvinyl siloxane gum having a Williams plasticity of 155 mm/100 and a vinyl content of 0.06 wt. % and 40 wt. % of calcium stearate.

Additive 9: Quartz sold as Silverbond 915 from Inabata & Co., Ltd.

Additive 10: Dispersion of 57 wt. % of dimethyl vinyl-terminated dimethyl siloxane gum having a having a Williams plasticity of 154 mm/100 and a vinyl content of 0.01 wt. % and 43 wt. % of cerium oxide.

Additive 11: 1,4-Butanediol.

Stabilizing additive 1: manganese(II) carbonate catalog No. 377449 from Sigma Aldrich

Stabilizing additive 2: dispersion of 85 wt. % of dimethylvinylsiloxy-terminated polydimethylsiloxane having a viscosity of about 2000 mPa·s at 25° C. using a Brookfield™ rotational viscometer with a cone plate arrangement with cone CP-52 at 3 rpm and 15 wt. % copper phthalocyanine commercially sold as LIONOL BLUE FG-7330 from Toyocolor.

Stabilizing additive 3: dispersion of 50 wt. % of dimethylvinylsiloxy-terminated polydimethylsiloxane having a viscosity of about 2000 mPa·s at 25° C. using a Brookfield™ rotational viscometer with a cone plate arrangement with cone CP-52 at 3 rpm.

and 50 wt. % iron (III) oxide commercially sold as BAYFERROX™ 110 M from Lanxess.

Stabilizing additive 4: Magnesium hydroxide commercially sold as Versamag™ from Akrochem Stabilizing additive 5: ground calcium carbonate with a mean particle size of 3 μm commercially sold as Atomite™ from Imerys.

Stabilizing additive 6: ammonium stearate surface treated ground calcium carbonate with a mean particle size of 3 m commercially sold as Gama-Sperse™ CS-11 from Imerys.

Stabilizing additive 7: zinc oxide, catalog No. 96479 from Sigma Aldrich.

Stabilizing additive 8: Sodium phosphate dibasic, catalog No. S9763 from Sigma Aldrich.

Stabilizing additive 9: magnesium carbonate hydrate commercially sold as Akrochem™ Light Magnesium Carbonate from Akrochem.

Stabilizing additive 10: magnesium oxide commercially sold as MAGOX™ 98 HR from Premier Magnesia, LLC.

Stabilizing additive 11: magnesium carbonate basic, light, catalog No. AC211070010 from Thermo Scientific™.

In the following examples, Tables 1a, 2a and 4a depict two-part LSR compositions. The compositions depicted in Tables 1a and 2a were all prepared as follows:

In the case of the compositions in Table 1a and 2a, two-part LSR compositions were prepared:
treated fumed silica 1, polymers 1 and 2, catalyst, additives 1, 2, and 3 and stabilizing additive were blended into a first part, part A and
treated fumed silica 1, polymers 1 and 2, crosslinker 1, inhibitor, additives 2, 3, and 4 and stabilizing additive were blended together into a second part, part B.

In the compositions in Table 4, a two-part LSR composition was prepared as follows:
treated fumed silica 2, polymers 1 and 2, catalyst, additives 1 and 5 and stabilizing additive were blended into a first part, part A and
treated fumed silica 2, polymers 1 and 2, crosslinker 2, inhibitor, additive 5 and stabilizing additive were blended together into a second part, part B.

In each composition the respective Parts A and B were mixed together to homogeneity in a 1:1 weight ratio to yield the liquid curable silicone elastomer compositions which were then cured by compression molding directly into a button mold at 171° C. for 20 minutes.

The compositions for Ref. 1 and Comparatives 1 to 8 (Comp. 1 to 8) are depicted in Table 1a.

TABLE 1a
Compositions of Ref. 1 and Comparative compositions C. 1 to C. 8 (wt. %)

| Ingredients | Ref 1 | C. 1 | C. 2 | C. 3 | C. 4 | C. 5 | C. 6 | C. 7 | C. 8 |
|---|---|---|---|---|---|---|---|---|---|
| Fumed Silica 1 | 30.41 | 30.10 | 29.19 | 29.80 | 30.10 | 30.10 | 30.10 | 30.10 | 30.10 |
| Polymer 1 | 59.96 | 59.40 | 57.58 | 58.80 | 59.40 | 59.40 | 59.40 | 59.40 | 59.40 |
| Polymer 2 | 5.00 | 4.95 | 4.80 | 4.90 | 4.95 | 4.95 | 4.95 | 4.95 | 4.95 |
| Karstedt's cat. | 0.19 | 0.18 | 0.18 | 0.18 | 0.18 | 0.18 | 0.18 | 0.18 | 0.18 |
| Cross-linker 1 | 1.62 | 1.60 | 1.55 | 1.58 | 1.60 | 1.60 | 1.60 | 1.60 | 1.60 |
| Inhibitor | 0.03 | 0.03 | 0.03 | 0.03 | 0.03 | 0.03 | 0.03 | 0.03 | 0.03 |
| Additive 1 | 0.10 | 0.09 | 0.09 | 0.09 | 0.09 | 0.09 | 0.09 | 0.09 | 0.09 |
| Additive 2 | 0.79 | 0.78 | 0.76 | 0.77 | 0.78 | 0.78 | 0.78 | 0.78 | 0.78 |
| Additive 3 | 1.87 | 1.85 | 1.80 | 1.83 | 1.85 | 1.85 | 1.85 | 1.85 | 1.85 |
| Additive 4 | 0.03 | 0.02 | 0.02 | 0.02 | 0.02 | 0.02 | 0.02 | 0.02 | 0.02 |
| Stab. Add. 1 | 0.00 | 1.00 | 0.00 | 0.00 | 0.00 | 0.00 | 0.00 | 0.00 | 0.00 |
| Stab. Add. 2 | 0.00 | 0.00 | 4.00 | 0.00 | 0.00 | 0.00 | 0.00 | 0.00 | 0.00 |
| Stab. Add. 3 | 0.00 | 0.00 | 0.00 | 2.00 | 0.00 | 0.00 | 0.00 | 0.00 | 0.00 |
| Stab. Add. 4 | 0.00 | 0.00 | 0.00 | 0.00 | 1.00 | 0.00 | 0.00 | 0.00 | 0.00 |
| Stab. Add. 5 | 0.00 | 0.00 | 0.00 | 0.00 | 0.00 | 1.00 | 0.00 | 0.00 | 0.00 |
| Stab. Add. 6 | 0.00 | 0.00 | 0.00 | 0.00 | 0.00 | 0.00 | 1.00 | 0.00 | 0.00 |
| Stab. Add. 7 | 0.00 | 0.00 | 0.00 | 0.00 | 0.00 | 0.00 | 0.00 | 1.00 | 0.00 |
| Stab. Add. 8 | 0.00 | 0.00 | 0.00 | 0.00 | 0.00 | 0.00 | 0.00 | 0.00 | 1.00 |

In order to assess the capability of each “stabilizing agent” utilised in the compositions of Table 1a, samples of the Reference and comparatives 1 to 8 were in each instance
(a) in a first test sandwiched on both top and bottom with aluminum substrates (A1) and (b) in a second test an equivalent sample was sandwiched on both top and bottom with a 25% glass fibre reinforced (GF25), flame-retardant PA6,6/6T-GF25 FR(40) (a commercially available halogen-free flame-retardant PA6,6/6T containing organophosphate flame-retardant known as Zytel™ FR95G25V0NH NC010 available from Dupont).

The samples were compressed at 25% for 168 hours at 175° C. in accordance with ASTM D395-18 method B.

Each of C.1 to C.8 were assessed to determine how many of the “stabilizing agents” functioned to stabilize the silicone elastomer samples tested and were not negatively affected by the presence of flame retardants. The results are depicted in Table 1b below.

The percentage change in compression set of PA6,6/6T-GF25 FR(40) to Al was determined by working out the difference between the compression set values when aluminium was the substrate and when the PA6,6/6T-GF25 FR(40) was the substrate which for Ref. 1 was

$$54.8 - 34.7 = 20.1$$

and then determining this value as a percentage of the aluminium value e.g.,

$$( 20.1 / 34.7 ) \times 100 = 57.9 \%$$

TABLE 1b
Compression set (%) results for cured samples of Ref. 1 and C. 1-C8 after compression
for 168 hours at 175° C. in accordance with ASTM D395 - 18 method B

| | Ref 1 | C. 1 | C. 2 | C. 3 | C. 4 | C. 5 | C. 6 | C. 7 | C. 8 |
|---|---|---|---|---|---|---|---|---|---|
| Aluminum | 34.7 | 28.4 | 19.2 | 26.8 | 27.7 | 31.8 | 32.1 | 39.9 | 37.9 |
| PA6T/66-GF25 FR(40) | 54.8 | 46.8 | 44.7 | 44.9 | 50.2 | 50.5 | 49.8 | 96.4 | 65 |
| % Change | 57.9 | 64.8 | 132.8 | 67.5 | 81.2 | 58.8 | 55.1 | 141.6 | 71.5 |

Comparative examples of compositions containing thermal stabilizers reported in the prior art for improving compression set of silicone elastomers such as manganese carbonate (C. 1), copper phthalocyanine (C.2) and iron oxide (C.3) show higher percent change in compression set than the Ref. 1 material. For example, C.1 containing manganese carbonate show a percent change of 64.8% when in contact with PA6,6/6T-GF25 FR(40).

Similar findings were observed for compositions containing acid scavengers reported in prior art such as magnesium hydroxide (C.4), which shows a percent change of 81.2%.

Comparative examples (C.5 to C.8) correspond to liquid curable silicone elastomer compositions containing stabilizing additives acting as acid scavengers.

Percent change in compression set of these comparative examples, when in contact with PA6,6/6T-GF25 FR(40) substrates, was similar or higher than Ref. 1 material. For example, percent change of C.5 composition containing calcium carbonate was 58.8% when in contact with PA6,6/6T-GF25 FR(40).

The above was considered surprisingly poor as it had been expected that one or two of the above proposed stabilization additives would have successfully assisted in maintaining the durability of the silicone elastomer but in each case significantly worse compression set results were achieved.

Indeed, even more surprisingly despite the introduction of the additive the results were at best similar to Ref. 1 but in the main were significantly worse. In the end none of the above were considered suitable stabilizing additives to help maintain the durability of silicone elastomers in direct contact with thermoplastics, e.g., in a silicone-thermoplastic composite with time.

A further series of samples were prepared and tested for compression set in the same way. The compositions used to generate the elastomer samples are detailed in Table 2a below with respect to Ref. 1 and Ex. 1 to 5. Samples were prepared, cured and tested for compression set in an identical manner as above although Ex. 4 and Ex. 5 were compressed between substrates of thermoplastic PA66-GF25 FR(40).

Inventive examples 1 to 3, disclosed in Table 2a, correspond to liquid curable silicone elastomer compositions containing a stabilizing additive selected from the group consisting of a magnesium carbonate, magnesium hydroxy carbonate and magnesium oxide such as light magnesium carbonate (hydromagnesite) (Akrochem) and Magox™ 98 HR magnesium oxide (Premier Magnesia, LCC) in contact with PA6,6/6T-GF25 FR(40).

Examples 4 and 5, correspond to liquid curable silicone elastomer compositions containing stabilizing additive 9 (Ex. 4) and stabilizing additive 10 (Ex. 5) in contact with an alternative thermoplastic PA66-GF25 FR(40), which is a commercially available 25% glass fibre reinforced (GF25), halogen-free flame-retardant PA6,6 containing organophosphate flame-retardant known as DURETHAN™ AKV25FN04 from Lanxess.

TABLE 2a
Compositions of Ex. 1 to 5 (wt. %)

| Ingredients | Ex. 1 | Ex. 2 | Ex. 3 | Ex. 4 | Ex. 5 |
|---|---|---|---|---|---|
| Fumed silica 1 | 30.10 | 29.95 | 30.10 | 30.10 | 30.10 |
| Polymer 1 | 59.40 | 59.10 | 59.40 | 59.40 | 59.40 |
| Polymer 2 | 4.95 | 4.92 | 4.95 | 4.95 | 4.95 |
| Karstedt's catalyst | 0.18 | 0.18 | 0.18 | 0.18 | 0.18 |
| Cross-linker 1 | 1.60 | 1.59 | 1.60 | 1.60 | 1.60 |
| Inhibitor | 0.03 | 0.03 | 0.03 | 0.03 | 0.03 |
| Additive 1 | 0.09 | 0.09 | 0.09 | 0.09 | 0.09 |
| Additive 2 | 0.78 | 0.78 | 0.78 | 0.78 | 0.78 |
| Additive 3 | 1.85 | 1.84 | 1.85 | 1.85 | 1.85 |
| Additive 4 | 0.02 | 0.02 | 0.02 | 0.02 | 0.02 |
| Stab. add 9 | 1.00 | 1.50 | 0.00 | 1.00 | 0.00 |
| Stab. add 10 | 0.00 | 0.00 | 1.00 | 0.00 | 1.00 |

These samples were cured and tested in the same manner as previously described and the results are provided in Table 2b below.

TABLE 2b
Compression set (%) results for cured samples of Ref. 1,
assessing both PA6T/66-GF25 FR(40) and PA66-GF25 FR(40)
as well as Ex. 1 to 5 after compression for 168 hours
at 175° C. in accordance with ASTM D395 - 18 method B

| | Ref | Ref | Ex. | Ex. | Ex. | Ex. | Ex. |
|---|---|---|---|---|---|---|---|
| | 1 | 1 | 1 | 2 | 3 | 4 | 5 |
| Aluminum | 34.7 | 34.7 | 35.2 | 45.3 | 40.3 | 35.2 | 40.3 |
| PA6T/66-GF25 | 54.8 | | 39.6 | 40.5 | 43.8 | | |
| FR(40) | | | | | | | |
| PA66-GF25 | | 62.7 | | | | 42.7 | 47.4 |
| FR(40) | | | | | | | |
| % Change | 57.9 | 80.7 | 12.5 | −10.6 | 8.7 | 21.3 | 17.6 |

Examples 1 and 2, which contain 1.0 and 1.5 wt. % of stabilizing additive 9 (light magnesium carbonate, otherwise known as hydromagesite), respectively, show a percent change in compression set of 12.5 and −10.6%, respectively, when in contact with PA6T/66-GF25 FR(40) substrate which are significantly lower than the Ref. 1. The negative percent change in Ex. 2 means that the compression set of Ex. 2 containing 1.5 wt. % of light magnesium carbonate in PA6T/66-GF25 FR(40) was lower (40.5%) than in Al (45.3%).

Similarly, a lower percent change in compression set (8.7%) was obtained for Ex. 3 containing stabilizing additive 10 (Magox™ 98 HR magnesium oxide) which is also lower than Ref. 1 material.

The percent change in compression set of Ex. 4 and 5 in PA66-GF25 FR(40) is 21.3 and 17.6, respectively, which is lower than Ref. 1 in this plastic (80.7%), thus confirming the benefit of stabilizing additives 9 and 10 in another type of flame retardant-rated thermoplastic.

The LSR composition identified above in Table 2a were used again to assess them when in contact with PBT GF25 FR(30+5×) (known as ULTRADUR™ B4450 G5 from Dupont) after a period of 1008 hours at 125° C. The results are provided in Table 3 below.

Ex. 6 and 7 have the same composition as Ex. 4 containing stabilizing additive 9. Ex. 8 and 9 have the same composition as Ex. 5 containing stabilizing additive 10.

Ex. 6 and 8 were in contact with PBT GF25 FR(30+5×) (known as ULTRADUR B4450 G5 from Dupont) and Ex. 7 and 9 were in contact with PBT GF25 FR(40) (known as POCAN BFN4231 from Lanxess).

The compression set change of examples 6 and 8 when in contact with PBT GF25 FR(30+5×) and Ex. 7 and 9 when in contact with PBT GF25 FR(40) were much improved when compared to the results seen using the Ref. 1 composition, thus demonstrating the benefit of stabilizing additives 9 and 10 in another type of flame retardant-rated thermoplastic and at different test conditions.

TABLE 3
Compression set (%) results for cured samples of Ref.
1 and Ex. 6 to 9 after compression for 1008 hours at
125° C. in accordance with ASTM D395 - 18 method B

| | Ref. 1 | Ref. 1 | Ex. 6 | Ex. 7 | Ex. 8 | Ex. 9 |
|---|---|---|---|---|---|---|
| Aluminum | 22.7 | 22.7 | 16.8 | 16.8 | 16.3 | 16.3 |
| PBT GF25 FR(30 + 5x) | 34.1 | | 22.8 | | 21.3 | |
| PBT GF25 FR(40) | | 35.6 | | 20.8 | | 19.9 |
| % Change | 50.2 | 56.8 | 35.7 | 23.8 | 30.7 | 22.1 |

A further comparison was made using the compositions in Table 4a, in which no additive 3 and 4 is present in either Ref. 2 or Ex. 10. Example 10 shown in Table 4a corresponds to a liquid curable silicone elastomer composition without either additives 3 (trimethylsilyl terminated phenylmethylsiloxane dimethylsiloxane copolymer) or additive 4 (ADK STAB™ CDA-6).

They did comprise stabilizing additive 9 (light magnesium carbonate).

TABLE 4a
Compositions of Ref. 2 and Ex. 10 (wt. %).

| | Ref. 2 | Ex. 10 |
|---|---|---|
| Fumed Silica 2 | 32.91 | 32.58 |
| Polymer 1 | 59.34 | 58.75 |
| Polymer 2 | 5.03 | 4.98 |
| Karstedt's cat. | 0.17 | 0.17 |
| Inhibitor | 0.04 | 0.04 |
| Crosslinker 2 | 1.19 | 1.18 |
| Additive 1 | 0.07 | 0.07 |
| Additive 5 | 1.25 | 1.24 |
| Stab. add 9 | 0.00 | 1.00 |
| Total | 100.00 | 100.00 |

Ref. 2 and Ex. 10 were tested after having been in contact with PA66-GF25 FR(40) and the results are depicted in Table 4b below.

TABLE 4b
Compression set (%) results for cured samples
after compression for 168 hours at 175°
C. in accordance with ASTM D395 - 18 method B.

| | Ref. 2 | Ex. 10 |
|---|---|---|
| Aluminum | 51.7 | 47.1 |
| PA66-GF25 FR(40) | 64.4 | 50.3 |
| % Change | 24.6 | 6.8 |

It will be appreciated that the percent change in compression set of Ex. 10 in PA66-GF25 FR(40) is 6.8, which is significantly lower than the Ref. 2.

In a further series of Examples, Examples 11, 12 and 13, disclosed in Table 5a, the compositions used correspond to liquid curable silicone elastomer compositions made of silica masterbatches 1 and 2 and containing stabilizing additives 9 (light magnesium carbonate (hydromagnesite, Akrochem), 10 (Magox™ 98 HR magnesium oxide, Premier Magnesia, LCC), and 11 (magnesium carbonate basic, light, catalog No. AC211070010, Thermo Scientific™). In the case of Ex. 11 to 13 in Table 5a, the liquid curable silicone elastomer compositions were prepared using masterbatches to prepare two-part composition:
MB1 and MB2, polymer 2, catalyst, additives 1, 2, and 3 and stabilizing additive were blended into a first part, (part A) and
masterbatches MB1 and MB2, polymer 2, cross-linker 1, inhibitor, additives 2, 3, and 4 and stabilizing additive were blended into a second part, part B. Once prepared, the two parts were mixed together to homogeneity in a 1:1 weight ratio to yield the liquid curable silicone elastomer compositions which were then cured as indicated above by compression molding directly into a button mold at 171° C. for 20 minutes.

TABLE 5a
Compositions of Ex. 11 to 13 (wt. %)

| Ingredients | Ex. 11 | Ex. 12 | Ex. 13 |
|---|---|---|---|
| Silica Masterbatch 1 | 84.12 | 85.12 | 83.13 |
| Silica Masterbatch 2 | 5.00 | 4.00 | 6.00 |
| Polymer 2 | 5.00 | 5.00 | 5.00 |
| Karstedt's catalyst | 0.19 | 0.19 | 0.19 |
| Cross-linker 1 | 1.87 | 1.87 | 1.86 |
| Inhibitor | 0.03 | 0.03 | 0.03 |
| Additive 1 | 0.10 | 0.10 | 0.10 |
| Additive 2 | 0.79 | 0.79 | 0.79 |
| Additive 3 | 1.87 | 1.87 | 1.87 |
| Additive 4 | 0.03 | 0.03 | 0.03 |
| Stabilizing additive 9 | 1.00 | 0.00 | 0.00 |
| Stabilizing additive 10 | 0.00 | 1.00 | 0.00 |
| Stabilizing additive 11 | 0.00 | 0.00 | 1.00 |

These samples were cured and tested in the usual way as discussed above and the compression set results are provided in Table 5b below.

TABLE 5b
Compression set (%) results for cured samples of
Ex. 11 to 13 after compression for 168 hours at
175° C. in accordance with ASTM D395 - 18 method B

| | Ex. 11 | Ex. 12 | Ex. 13 |
|---|---|---|---|
| Aluminum | 56.4 | 55.3 | 54.8 |
| PA66-GF25 FR(40) | 53.1 | 51.4 | 57.6 |
| % Change | −5.9 | −7.1 | 5.1 |

The compression set change of examples 11, 12 and 13 was −5.9%, −7.1%, and 5.1% when in contact with PA66-GF25 FR(40) were much improved over the reference results.

In a further set of results a peroxide cure composition was prepared and cured. The compositions utilised are depicted in Table 6a with a silicone rubber base was prepared by mixing silicone gums 1, 2, and 3, fumed silica 3, precipitated silica, and additives 3, 5, 6, 7, 8, 9, 10, and 11.

Then the silicone base was milled along with a peroxide catalyst.

Once the peroxide was entirely mixed in the product, the stabilizing additive was added and further milled another 7-10 times to ensure good mixing. The silicone rubber was then cured by compression molding into a button for 15 minutes at 171° C. and then subsequently post-cured for 4 hours at 200° C.

TABLE 6a
Compositions of Ref. 3 and Ex. 14 (wt. %).

| | Ref. 3 | Ex. 14 |
|---|---|---|
| Silicone Gum 1 | 1.45 | 1.45 |
| Silicone Gum 2 | 41.32 | 41.32 |
| Silicone Gum 3 | 13.77 | 13.77 |
| Fumed silica 3 | 19.79 | 19.79 |
| Precipitated silica | 2.83 | 2.83 |
| Additive 3 | 4.53 | 4.53 |
| Additive 5 | 3.68 | 3.68 |
| Additive 6 | 0.17 | 0.17 |
| Additive 7 | 0.68 | 0.68 |
| Additive 8 | 0.28 | 0.28 |
| Additive 9 | 10.15 | 10.15 |
| Additive 10 | 1.01 | 1.01 |
| Additive 11 | 0.34 | 0.34 |
| Base | 100.00 | 100.00 |
| Peroxide Catalyst | 0.8 | 0.8 |
| Stab. add 9 | | 1 |

Hence, Ex. 14 disclosed in Table 6a, correspond to a peroxide cured silicone rubber containing stabilizing additive 9. The compression set (%) results for cured samples of Ref. 3 and Ex. 11 were determined after compression for 168 hours at 175° C. in accordance with ASTM D395-18 method B and the results are depicted in Table 65b below.

TABLE 6b
Compression set (%) results for cured samples
after compression for 168 hours at 175°
C. in accordance with ASTM D395 - 18 method B.

| | Ref. 3 | Ex. 14 |
|---|---|---|
| Aluminum | 38.3 | 44.1 |
| PA6T/66-GF33 FR(40) | 64.5 | 52.9 |
| % Change | 46.3 | 38.1 |

It will be seen that the percent change in compression set of Ex. 14 in a PA6T/66-GF33 FR(40) plastic after testing for 168 hours at 175° C. was 38.1%, which is less than the Ref. 3 showing the benefit of using this magnesium additive in a peroxide cure system providing compression set stability when in contact with a FR-rated thermoplastic.

In summary, all eleven examples gave results which are dramatically better than the respective reference examples 1, 2 and 3 and indeed all the comparatives. The improvement was dramatic and positively surprising, given failure had been anticipated before conducting the examples in view of the results for the compositions in Table 1.

It would seem that there is some form of synergistic effect caused by using magnesium carbonates, magnesium hydroxy carbonates, magnesium oxide or a mixture and such materials are successful in interacting with the species migrating into the silicone elastomer in the composite preventing worsening of compression set and as such maintaining the durability of the silicone in the composite articles despite their physical interactions with the thermoplastics.

1. A silicone-thermoplastic composite article comprising:
(i) a thermoplastic article comprising one or more flame-retardant additives, wherein the thermoplastic article has an available surface; and
(ii) a cured silicone elastomer part in direct contact with the available surface of the thermoplastic article (i), wherein the silicone elastomer part is the cured product of a silicone elastomer composition comprising from 0.25 wt. % to a maximum of 5 wt. % of a stabilizing additive selected from the group consisting of magnesium carbonates, magnesium hydroxy carbonates, magnesium oxide, and mixtures thereof.

2. The silicone-thermoplastic composite article in accordance with claim 1, wherein the thermoplastic article (i) is selected from a polyamide, polyoxymethylene, polyphenylenesulfide (PPS), polyacetals, polyamide-imides, polypthalamides, polyetherimides, polyetherketone, polyether etherketone, polyether ketone ether ketone, polyoxymethylene(acetal) homopolymer copolymer, syndiotactic polystyrene (sPS), a compatibilized blend of sPS with polyamide, polyesters, polycarbonate (PC), polyethers, maleic anhydride grafted polyphenyleneoxide (PPO), maleic anhydride grafted olefinic elastomers and plastomers, polysulfone, polyethersulfone, polyarylsulfone, polyphenylene ether, polypropylene, polyethylene, aliphatic polyketones (PK) thermoplastic styrene copolymers, polymethyl methacrylate (PMMA), and polyoxymethylene (POM).

3. The silicone-thermoplastic composite article in accordance with claim 2, wherein the thermoplastic article (i) comprises at least one of PA6, PA6,6, PA6T/6,6, PBT, PC or PK, and optionally comprises up to about 35 wt. % of glass fibers (GF) as a reinforcement additive.

4. The silicone-thermoplastic composite article in accordance with claim 1, wherein the thermoplastic article (i) comprises at least one flame-retardant additive selected from brominated flame-retardants, chlorinated paraffins, melamine-based flame-retardants, organo-phosphorus flame-retardants, polyphosphates flame-retardants, and metal hydroxide flame-retardants, as well as mixtures or derivatives thereof.

5. The silicone-thermoplastic composite article in accordance with claim 1, wherein the stabilizing additive is selected from magnesite (MgCO₃), barringtonite (MgCO₃·2H₂O), nesquihonite (MgCO₃·3H₂O), lansfordite (MgCO₃·5H₂O), perovskite (Mg₂(CO₃)(OH)₂·5H₂O), artinite (Mg₂(CO₃)(OH)₂·3H₂O), hydromagnesite (Mg₅(CO₃)₄(OH)₂·4H₂O), dypingite (Mg₅(CO₃)₄(OH)₂·5H₂O), giorgiosite (Mg₅(CO₃)₄(OH)₂·5-6H₂O), and shelkovite (Mg₇(CO₃)₅(OH)₄·24H₂O), and optionally comprises at least one metal deactivator.

6. The silicone-thermoplastic composite article in accordance with claim 5, wherein the metal deactivator is selected from a diacylhydrazide-based compound, an aminotriazole-based compound, an amino-containing triazine-based compound, or a mixture thereof.

7. The silicone-thermoplastic composite article in accordance with claim 1, wherein in use the silicone elastomer part is sandwiched between two articles at least one of which is a thermoplastic article comprising one or more flame-retardant additives.

8. The silicone-thermoplastic composite article in accordance with claim 1, wherein in use the silicone elastomeric part is subjected to mechanical compression and exposed to temperatures of greater than 85° C.

9. The silicone-thermoplastic composite article in accordance with claim 1, wherein the silicone elastomer part is the cured product of a hydrosilylation reaction curable silicone elastomer composition or a free radical reaction curable silicone elastomer composition.

10. The silicone-thermoplastic composite article in accordance with claim 1, which is an automotive part, a cable accessory, an electrical part, an electronic part, a packaging part, a construction part, a household part or a gasket.

11. The silicone-thermoplastic composite article in accordance with claim 10, which is an electrical or electronic connector having a silicone elastomer seal or an electrical module housing optionally with a sealed lid or electronic module housing optionally with a sealed lid, a radiator tank, a valve cover assembly, a sealed headlamp assembly, a potted electronic component or an encapsulated electronic component.

12. A method of fabricating the silicone-thermoplastic composite article in accordance with claim 1, the method comprising:
(a) providing a curable silicone elastomer composition comprising from 0.25 wt. % to a maximum of 5 wt. % of a stabilizing additive selected from the group consisting of magnesium carbonates, magnesium hydroxy carbonates, magnesium oxide, and mixtures thereof;
(b) curing the curable elastomer composition into a mold to provide a cured silicone elastomer; and
(c) physically engaging the cured silicone elastomer with an available surface of a thermoplastic article comprising one or more flame-retardant additives, to form a silicone-thermoplastic composite article.

13. A method of fabricating the silicone-thermoplastic composite article in accordance with claim 1, the method comprising:
(a) providing a curable silicone elastomer composition comprising from 0.25 wt. % to a maximum of 5 wt. % of a stabilizing additive selected from the group consisting of magnesium carbonates, magnesium hydroxy carbonates, magnesium oxide, and mixtures thereof;
(b) contacting the curable silicone elastomer composition with an available surface of a thermoplastic article comprising one or more flame-retardant additives; and
(c) curing the curable silicone elastomer composition in contact with the available surface of the flame-retardant thermoplastic article, to form a silicone-thermoplastic composite article.

14. A method for fabricating a silicone-thermoplastic composite article, wherein the silicone-thermoplastic composite article comprises:
(i) a thermoplastic article comprising one or more flame-retardant additives,
wherein the thermoplastic article has an available surface; and
(ii) a silicone elastomer part, wherein the silicone elastomer part is physically engaged with the available surface of (i) the thermoplastic article;
which method comprises:
(1) providing a curable silicone elastomer composition comprising a hydrosilylation reaction curable silicone elastomer composition or a free radical reaction curable silicone elastomer composition,
wherein the curable silicone elastomer composition comprises 0.25 wt. % to a maximum of 5.0 wt. % of a stabilizing additive selected from the group consisting of magnesium carbonates, magnesium hydroxy carbonates, magnesium oxide, and mixtures thereof;
(2) introducing a desired amount of the curable silicone elastomer composition into a mold;
(3) curing the curable silicone elastomer composition, thereby forming (ii) the silicone elastomer part; and
(4) physically engaging (ii) the silicone elastomer part and the available surface of (i) the thermoplastic article, thereby forming the silicone-thermoplastic composite article.

15. The method for fabricating a silicone-thermoplastic composite article in accordance with claim 14, wherein the silicone-thermoplastic composite article is an electrical or electronic connector, and wherein the electrical or electronic connector comprises;
(ia) one or more electrical wires; and
(ib) an electrical or electronic connector housing comprising a thermoplastic material and one or more flame-retardant additives;
wherein the electrical or electronic connector housing (ib) has a first available surface and a second surface opposite the first available surface,
wherein the second surface defines a cavity, and
the cavity houses the one or more electrical wires (ia) therein; and
wherein the silicone elastomer part (ii) is a silicone elastomer seal, wherein the silicone elastomer seal is physically engaged with the first available surface of the electrical or electronic connector housing (ib).

16. A method to maintain the durability of a silicone elastomer part in physical contact with a flame-retardant thermoplastic having an available surface which silicone elastomer part in use is subjected to mechanical compression and exposed to temperatures of greater than 85° C., the method comprising the steps of:
(1′) preparing a curable silicone elastomer composition, wherein the curable silicone elastomer composition comprises 0.25 wt. % to a maximum of 5.0 wt. % of a stabilizing additive selected from the group consisting of magnesium carbonates, magnesium hydroxy carbonates, magnesium oxide, and mixtures thereof;
(2′) introducing a desired amount of the curable silicone elastomer composition into a mold;
(3′) curing the curable silicone elastomer composition, thereby forming the silicone elastomer part; and
(4′) physically engaging the silicone elastomer part and the available surface of the flame-retardant thermoplastic, to form a silicone-thermoplastic composite article.

17-21. (canceled)
